(19) United States
(12) Patent Application Publication
(10) Pub. No.: US 2014/0043444 A1
(43) Pub. Date: Feb. 13, 2014

(54) STEREO CAMERA DEVICE AND COMPUTER-READABLE RECORDING MEDIUM

(71) Applicants: Kazuma Haraguchi, Osaka (JP); Nobuhiro Miichi, Hyogo (JP); Tomoharu Nakahara, Hyogo (JP)

(72) Inventors: Kazuma Haraguchi, Osaka (JP); Nobuhiro Miichi, Hyogo (JP); Tomoharu Nakahara, Hyogo (JP)

(73) Assignee: PANASONIC CORPORATION, Osaka (JP)

(21) Appl. No.: 14/113,975

(22) PCT Filed: May 30, 2012
(86) PCT No.: PCT/JP2012/063964

§ 371 Date: Oct. 25, 2013

(30) Foreign Application Priority Data
May 30, 2011 (JP) 2011-120757

(51) Int. Cl. H04N 13/02

(52) U.S. Cl. CPC H04N 13/0239
USPC 348/47

(57) ABSTRACT

The stereo camera device includes: a pair of cameras; a first converter converting images of the cameras into first conversion images; a second converter converting the images into second conversion images; and a disparity estimation unit. The first conversion image is an image in which positions of pixels are represented by two-dimensional orthogonal coordinates defined by a first angle around a first axis defined by a straight line connecting optical centers of the cameras and a second angle around a second axis defined by an optical axis of the camera. The second conversion image is an image in which positions of pixels are represented by two-dimensional orthogonal coordinates defined by the first angle and a third angle around a third axis orthogonal to the first and second axes. The disparity estimation unit calculates a disparity of a desired point in a space based on the first and second conversion images.

### TECHNICAL FIELD

The present invention relates to stereo camera devices and computer-readable media and more particularly to a stereo camera device for obtaining three-dimensional information of a space with a principle of triangulation using images captured by a plurality of cameras and a computer-readable recording medium storing a program for enabling a computer to operate as the stereo camera device.

### BACKGROUND ART

In the past, the stereo vision has been known as a technique for obtaining three-dimensional information of a space. The stereo vision is a technique of calculating a distance to a desired part in the three-dimensional real space by applying a principle of triangulation on images of a real space taken by a plurality of cameras. Specifically, in the stereo vision, images of the three-dimensional real space are taken by a plurality of cameras that are arranged such that fields of view thereof are partly overlapped with each other. When an image of the desired part in the real space is produced on an imaging device of each camera, the distance to the desired part in the real space is measured with the principle of triangulation using directions from an optical center in the real space to the desired part, a relative position between cameras, and postures,

The following explanation relates to images (hereinafter referred to as “captured images”) taken by two cameras. To measure the distance to the desired part from the two captured images requires information about: a length (hereinafter referred to as “base line length”) of a segment connecting optical centers of the two cameras; and a distance corresponding to a difference between positions of images in the two captured images corresponding to the desired part in the real. The distance corresponding to the difference between the positions of the images is equal to a disparity between images taken by the two cameras that view the desired part in the real space. As the distance corresponding to the difference between the positions of the images, a difference between distances from reference positions respectively set on the two captured images to the desired part is used.

To calculate the disparity from the captured images, it is necessary to search the captured images for positions of images corresponding to the desired part in the real space. In other words, it is necessary to determine corresponding points relating to the same part with regard to the two captured images taken by the two cameras. The process of searching the two captured images for the corresponding points is so-called stereo matching. In view of an epipolar plane intersecting the optical centers of the two cameras and the desired part in the real space, an area of the captured image to be searched for the corresponding point in the stereo matching can be limited to a line that is a projection of the epipolar plane on the captured image.

As for the stereo vision, in many cases, a parallel stereo method is used. In the parallel stereo method, two cameras are arranged such that the optical axes thereof are parallel to each other and a straight line (hereinafter referred to as “base line”) connecting the optical centers of the cameras is perpendicular to the optical axes thereof. Hereinafter, the parallel stereo method in which a direction of the base line is identical to horizontal directions of the captured images created by the respective cameras is referred to as a parallel stereo method for simplifies the explanation.

For example, it is assumed that the captured image does not suffer from distortion that is caused by an optical system (e.g., a lens) provided to a camera. In this case, as shown in FIG. 19, lines defined by projections of the epipolar plane 403 on the captured images 401 and 402 are straight lines that are parallel to horizontal direction of the captured images 401 and 402, respectively. The epipolar plane 403 is formed corresponding to the desired part P1 in the real space. In the following explanations, with regard to each of the captured images 401 and 402, a horizontal direction is defined as an x-direction and a vertical direction is defined as a y-direction. Thus, the x-direction is parallel to a base line 404. Hence, the straight lines obtained by projecting the epipolar plane 403 on the captured images 401 and 402 are parallel to the x-directions of the captured images 401 and 402, respectively, and a coordinate of each straight line is constant in the y-direction.

When an image G1 corresponding to the part P1 in the real space is present in one captured image 401, a scanning area for an image D1 corresponding to the part P1 present in the other captured image 402 is limited to a horizontal straight line that has the same coordinate in the y-direction as that of the image G1. For example, in FIG. 19, the image G1 is on a straight line 405 that passes through the optical center O1 of one camera and the image G1. Hence, parts P1, P2, and P3 on this straight line 405 are corresponding to the image G1, for example. In contrast, straight lines that pass the optical center O2 of the other camera and the parts P1, P2, and P3 are corresponding to the images D1, D2, D3 in the captured image 402, respectively. In this regard, the image G1 and the images D1, D2, D3 have the same coordinate in the y-direction.

As described above, according to the stereo matching with the parallel stereo method, the desired part in the real space is associated with positions that are the same in the vertical direction in the captured images from the respective cameras. In other words, when the two cameras take images of the same part in the real space, the positions of the pixels in the captured images corresponding to the part are different in the horizontal direction and the same in the vertical direction. In the parallel stereo method, it is sufficient that the captured images are searched in the horizontal direction for the points corresponding to the same part in the real space with regard to the captured images obtained by the cameras. Hence, the parallel stereo method has an advantageous effect that the processing efficiency of the stereo matching is improved.

The technique of the parallel stereo method described above stands on the assumption that optical systems of cameras have no distortion. Hence, the high processing efficiency of the stereo matching can be obtained only in the following cases. In one case, the angle of view is enough small in such an extent that an adverse effect due to distortion of the optical system of the camera is considered to be ignorable, and in the other case, even when the optical system has distortion, an adverse effect due to this distortion can be removed with correction. In other words, when the optical system (e.g., a fisheye lens) having large distortion is used to increase an angle of view, the processing load in the stereo matching is likely to be greatly increased.

Generally, an image taken by use of the optical system having a wide angle of view such as a fisheye lens shows curvature distortion in which curvature becomes greater towards a periphery of the image. Hence, in the stereo matching, it is necessary to search for the corresponding points in view of such curvature distortion. In other words, to search for the corresponding points, both the coordinate in the x-direction and the coordinate in the y-direction are changed. This is likely to cause a decrease in the processing efficiency of searching for the corresponding points, and further to cause an increase in the possibility that associating the desired part with the corresponding points results in failure. Consequently, there is a problem that the distance is missmeaured and this leads to a decrease in the measurement performance.

In order to solve the problem described above, there has been proposed the following technique. In this technique, a conversion image is created by performing coordinate conversion on the captured image such that the projection of the epipolar plane on the image is a straight line, and the stereo matching is performed by use of this conversion image. In this conversion image, the coordinate axes are determined such that the projection of the epipolar plane is a straight line parallel to a lateral axis (e.g., see document 1: JP 2007-24647 A, document 2: JP 2009-139246 A, and document 3: Fish-Eye-Stereo Calibration and Epipolar Rectification, Abraham, S. Forstner. W. International Journal of Photogrammetry and Remote Sensing, Vol. 59, Issue 5, August 2005).

According to the techniques disclosed in documents 1 to 3, to efficiently estimate the disparity from the images having a wide angle of view, an angle β around an axis extending along the direction (x-direction) of the base line 404 is associated with a vertical axis of the conversion image, as shown in FIG. 20. Using such a conversion image enables associating the part P1 in the three-dimensional real space with the same angle β with regard to the two captured images. Hence, like the parallel stereo method, the search for the corresponding points is facilitated, and therefore it is possible to efficiently estimate the disparity. Note that, a hemisphere shown in FIG. 20 represents an optical system.

As shown in FIG. 21, documents 1 and 3 use, as the horizontal axis in the conversion image, an angle γ within the epipolar plane 403. This angle γ is an angle of a straight line connecting the desired part P1 and the optical center O of the camera with respect to a plane (yz-plane) defined by the vertical direction (y-direction) and the direction of the optical axis (z-direction) in the light receiving surface of the camera.

In contrast, as shown in FIG. 22, document 2 uses, as the horizontal axis in the conversion image, a tangent (tan α) of an angle α around an axis extending along the vertical direction (direction perpendicular to the directions of the base line 404 and the optical axis) of the captured image.

When a movement of a person in a room is detected with the technique of obtaining the three-dimensional information in the real space, such a detection result is applicable for control on a load device in the room, for example. For example, in a case of an air-conditioning load, by determining a location of a person in a room, it is possible to intensively supply cool air or warm air to the determined location of a person. Alternatively, in a case of a load device displaying an image, the load device can change a direction and/or a size of the image in accordance with the location of a person.

Also in cases other than the control of the load device, for the purpose of obtaining the three-dimensional information of the in-room space, to include an entire room in a field of view and avoid the interruption of line of sight by persons or objects, it is preferable that cameras are arranged around a center of a ceiling such that optical axes thereof are parallel to a vertical direction, for example. For example, it is preferable that cameras are arranged around a center of a ceiling such that optical axes thereof are parallel to a vertical direction. According to this arrangement, a lot of information regarding horizontal objects (such as floor surfaces and things on floor surfaces) can be obtained from the center region of the captured image, and a lot of information regarding vertical objects (such as wall surfaces and pillars) can be obtained from the peripheral region of the captured image.

By using the techniques disclosed in documents 1, 2, and 3 mentioned above, it is possible to reduce the adverse effect of distortion in the captured image caused by using the optical system having a wide angle of view. However, it remains impossible to sufficiently remove distortion in the captured image.

For example, as shown in FIG. 23 (a), an image of a straight line L1 parallel to the optical axis (z-direction) is taken. In this case, as shown in FIG. 23 (b), the conversion image shows this line L1 as a distorted curve line L2. FIG. 23 shows an instance in accordance with document 1. In this conversion image, the angle γ is associated with the horizontal axis, and the angle β is associated with the vertical axis. Hence, according to the technique disclosed in document 1, the straight line L1 is expressed as the curved line L2 in the conversion image unless a relation of β=γ is satisfied. Likewise, such distortion is likely to occur in the conversion images disclosed in documents 2 and 3.

As can be seen from FIG. 23 (b), linearity is relatively high in the center region of the conversion image but is decreased in the peripheral region of the conversion image. For this reason, with regard to objects along the vertical direction such as walls and pillars present in the peripheral region of the conversion image, the efficiency of processing of searching for the corresponding points is decreased.

Additionally, as shown in FIG. 24, even when the image of the same straight line L1 (see FIG. 23) are taken, this image is shown as the curved lines L21 and L22 having different shapes in the conversion images obtained from the respective two captured images. Hence, it is not easy to search the two conversion images for the corresponding points. In conclusion, the process of searching for the corresponding points is not easy even when any of the techniques of documents 1, 2, and 3 is used.

### SUMMARY OF INVENTION

In view of the above insufficiency, the present invention has aimed to propose a stereo camera device and a computer-readable recording medium which can more facilitate a search for corresponding points of images taken by a plurality of cameras.

The stereo camera device of the first aspect in accordance with the present invention includes: a stereo camera unit; and an arithmetic processing unit. The stereo camera unit includes a pair of cameras for capturing images of a predetermined space, and is configured to provide the captured images respectively by the pair of cameras to the arithmetic processing unit. The arithmetic processing unit includes a first converter, a second converter, and a disparity estimation unit. The first converter is configured to convert the captured images by the pair of cameras into first conversion images. The first conversion image is defined as an image in which a position of a pixel is represented by two-dimensional orthogonal coordinates defined by a first angle around a first axis and a second angle around a second axis. The second converter is configured to convert the captured images by the pair of cameras into second conversion images. The second conversion image is defined as an image in which a position of a pixel is represented by two-dimensional orthogonal coordinates defined by the first angle and a third angle around a third axis. The first axis is defined by a straight line connecting optical centers of the pair of cameras to each other. The second axis is defined by an optical axis of the camera. The third axis is defined by an axis orthogonal to the first axis and the second axis. The disparity estimation unit is configured to calculate a disparity regarding a desired point in the space based on the first conversion images obtained by the first converter and the second conversion images obtained by the second converter.

With regard to the stereo camera device of the second aspect in accordance with the present invention, in addition to the first aspect, the disparity estimation unit is configured to calculate corresponding points regarding the desired point from the two first conversion images respectively corresponding to the pair of cameras, and calculate a first disparity regarding the desired point based on the corresponding points, and evaluate a first degree of coincidence between the corresponding points of the two first conversion images. The disparity estimation unit is configured to calculate corresponding points regarding the desired point from the two second conversion images respectively corresponding to the pair of cameras, and calculate a second disparity regarding the desired point based on the corresponding points, and evaluate a second degree of coincidence between the corresponding points of the two second conversion images. The disparity estimation unit is configured to compare the first degree of coincidence with the second degree of coincidence with regard to the same desired point, and select the first disparity as the disparity regarding the desired point when the first degree of coincidence is higher than the second degree of coincidence, and select the second disparity as the disparity regarding the desired point when the first degree of coincidence is lower than the second degree of coincidence.

With regard to the stereo camera device of the third aspect in accordance with the present invention, in addition to the second aspect, the arithmetic processing unit further includes a region evaluation unit. The region evaluation unit is configured to calculate a first evaluation value regarding a change in a luminance value with regard to a first pixel of the first conversion image and a second evaluation value regarding a change in a luminance value with regard to a second pixel of the second conversion image corresponding to the first pixel. The region evaluation unit is configured to calculate a difference between the first evaluation value and the second evaluation value and compare the difference with a predetermined threshold. The region evaluation unit is configured to compare the change in the luminance value of the first pixel and the change in the luminance value of the second pixel when the difference exceeds the threshold. The region evaluation unit is configured to select a first condition for the first pixel and the second pixel when the change in the luminance value of the first pixel exceeds the change in the luminance value of the second pixel. The region evaluation unit is configured to select a second condition for the first pixel and the second pixel when the change in the luminance value of the first pixel falls below the change in the luminance value of the second pixel. The region evaluation unit is configured to select a third condition for the first pixel and the second pixel when the difference is equal to the threshold or less. The region evaluation unit is configured to, when the first condition is selected for the first pixel and the second pixel, calculate the corresponding points by use of the first conversion images with regard to the first pixel and the second pixel. The region evaluation unit is configured to, when the second condition is selected for the first pixel and the second pixel, calculate the corresponding points by use of the second conversion images with regard to the first pixel and the second pixel. The region evaluation unit is configured to, when the third condition is selected for the first pixel and the second pixel, calculate the corresponding points by use of the first conversion images and the second conversion images with regard to the first pixel and the second pixel.

With regard to the stereo camera device of the fourth aspect in accordance with the present invention, in addition to the second aspect, the first converter is configured to decide a first extraction region used for extracting the corresponding point from the first conversion image in accordance with a predetermined first decision condition, and calculate a pixel value regarding a pixel included in the first extraction region, and not calculate a pixel value regarding a pixel not included in the first extraction region. The second converter is configured to decide a second extraction region used for extracting the corresponding point from the second conversion image in accordance with a predetermined second decision condition, and calculate a pixel value regarding a pixel included in the second extraction region, and not calculate a pixel value regarding a pixel not included in the second extraction region.

With regard to the stereo camera device of the fifth aspect in accordance with the present invention, in addition to any one of the first to fourth aspects, the stereo camera device includes a plurality of stereo camera units. The plurality of stereo camera units are arranged such that the first axes thereof cross each other and the second axes thereof are parallel to each other. The disparity estimation unit is configured to calculate the disparity regarding the desired point for each of the plurality of stereo camera units. The arithmetic processing unit includes a selection processing unit. The selection processing unit is configured to calculate a degree of reliability for each disparity calculated by the disparity estimation unit, and select the disparity having the highest degree of reliability from the disparities estimated by the disparity estimation unit.

With regard to the stereo camera device of the sixth aspect in accordance with the present invention, in addition to the fifth aspect, one of the two cameras of one of the plurality of stereo camera units is used as one camera of another stereo camera unit.

The computer-readable recording medium of the seventh aspect in accordance with the present invention is a computer-readable recording medium storing a program used in a computer connected to a stereo camera unit. The stereo camera unit includes a pair of cameras for capturing images of a predetermined space, and is configured to provide the captured images respectively by the pair of cameras to the arithmetic processing unit. The pair of cameras are arranged such that optical axes thereof are parallel to each other and fields of view thereof are overlapped with each other. The program is designed to have the computer functions a first converter, a second converter, and a disparity estimation unit. The first converter is configured to convert the captured images by the pair of cameras into first conversion images. The first conversion image is defined as an image in which a position of a pixel is represented by two-dimensional orthogonal coordinates defined by a first angle around a first axis and a second angle around a second axis. The second converter is configured to convert the captured images by the pair of cameras into second conversion images. The second conversion image is defined as an image in which a position of a pixel is represented by two-dimensional orthogonal coordinates defined by the first angle and a third angle around a third axis. The first axis is defined by a straight line connecting optical centers of the pair of cameras to each other. The second axis is defined by an optical axis of the camera. The third axis is defined by an axis orthogonal to the first axis and the second axis. The disparity estimation unit is configured to calculate a disparity regarding a desired point in the space based on the first conversion images obtained by the first converter and the second conversion images obtained by the second converter.

### BRIEF DESCRIPTION OF THE DRAWINGS

FIG. 1 is a block diagram illustrating the stereo camera device of the first embodiment;

FIG. 2 is a diagram illustrating the principle of the above embodiment;

FIG. 3 is a diagram illustrating the relation regarding the coordinate system used in the above embodiment;

FIG. 4 is a diagram illustrating the relation regarding the coordinate system used in the above embodiment;

FIG. 5 is a diagram illustrating an example of the image in the above embodiment;

FIG. 6 is a diagram illustrating an example of the first conversion image in the above embodiment;

FIG. 7 is a diagram illustrating an example of the second conversion image in the above embodiment;

FIG. 8 is a diagram illustrating block matching in the above embodiment;

FIG. 9 is a diagram illustrating block matching in the above embodiment;

FIG. 10 is a diagram illustrating the outline of the operation of the above embodiment;

FIG. 11 is a block diagram illustrating the stereo camera device of the second embodiment;

FIG. 12 is a diagram illustrating the operation of the above embodiment;

FIG. 13 is a diagram illustrating an example of the regions obtained by dividing in the above embodiment;

FIG. 14 is a diagram illustrating the regions in the stereo camera device of the third embodiment;

FIG. 15 is a diagram illustrating the region in the above embodiment;

FIG. 16 is a block diagram illustrating the stereo camera device of the fourth embodiment;

FIG. 17 is a schematic diagram illustrating the configuration of the stereo camera device of the fifth embodiment;

FIG. 18 is a block diagram illustrating the above embodiment;

FIG. 19 is a diagram illustrating the concept of the stereo vision;

FIG. 20 is a diagram illustrating the prior art;

FIG. 21 is a diagram illustrating the coordinate system used in the above prior art;

FIG. 22 is a diagram illustrating the coordinate system used in the above prior art;

FIG. 23 is a diagram illustrating the operation of the above prior art; and

FIG. 24 is a diagram illustrating the operation of the above prior art.

### DESCRIPTION OF EMBODIMENTS

### First Embodiment

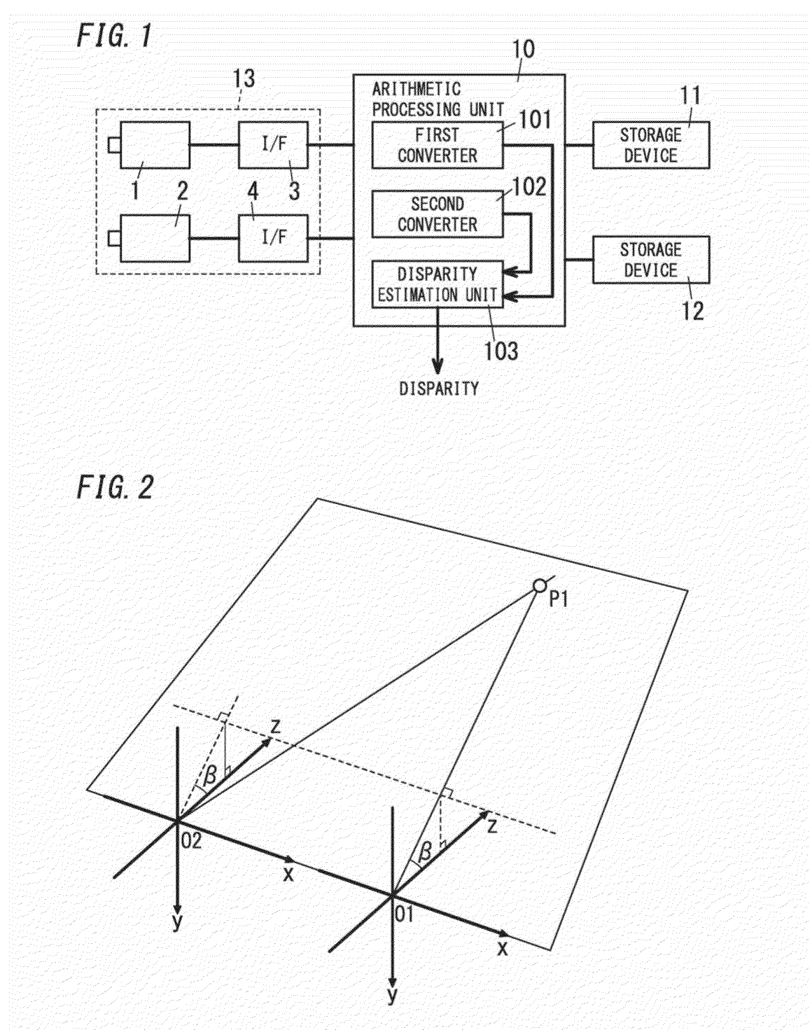

As shown in FIG. 1, the stereo camera device of the present embodiment includes: a stereo camera unit 13 including a pair of cameras (a first camera and a second camera) 1 and 2; an arithmetic processing unit 10; and storage devices 11 and 12. The stereo camera device of the present embodiment is described in detail below.

As shown in FIG. 1, the stereo camera device of the present embodiment includes the two cameras (first and second cameras) 1 and 2 arranged such that fields of view thereof are substantially overlapped with each other with regard to a three-dimensional real space. The cameras 1 and 2 are arranged such that optical axes thereof are parallel to each other and are orthogonal to a direction (base line direction) of a straight line connecting optical center (imaging center) thereof.

The cameras 1 and 2 are arranged to have the optical axes parallel to each other. Further, the cameras 1 and 2 are arranged such that a straight line (base line) connecting the optical centers O1 and O2 of the respective cameras 1 and 2 is orthogonal to the optical axes of the respective cameras 1 and 2. Furthermore, the cameras 1 and 2 are arranged such that the fields of view thereof are overlapped with each other.

Each of the cameras 1 and 2 includes an optical system that has the same function as or substantially the same function as a fisheye lens with an angle of view of approximately 180°. The projection of the optical system is not limited to particular one, but the following explanation is made based on the equidistance projection. Further, each of the two cameras 1 and 2 is positioned such that a horizontal direction of a light receiving surface (imaging surface) is identical to the base line direction. In brief, the present embodiment relates to the parallel stereo method.

Besides, in the following, with regard to the three-dimensional real space, a direction (i.e., the base line direction) extending along the horizontal direction of the light receiving surface is defined as an x-direction, and a direction extending along a vertical direction of the light receiving surface is defined as a y-direction, and a direction normal to the light receiving surface is defined as a z-direction. Notably, the horizontal direction of the light receiving surface means a direction of a first axis of a two-dimensional orthogonal coordinate system defining the light receiving surface, but does not mean a horizontal direction of the real space. The vertical direction of the light receiving surface means a direction of a second axis of the two-dimensional orthogonal coordinate system defining the light receiving surface, but does not mean a vertical direction of the real space.

The coordinate system is determined such that a right direction in the horizontal direction is identical to a positive direction in the x-direction and a downward direction in the vertical direction is identical to a positive direction in the y-direction when a captured image by each camera is displayed by a monitoring device. With regard to the z-direction, a positive direction is selected as a direction away from the light receiving surface of the camera. In other words, the positive direction in the z-direction is identical to a front direction of the camera.

For example, a position of a pixel in the captured image by each of the cameras 1 and 2 is represented by use of a first coordinate system (image coordinate system) defined as a two-dimensional orthogonal coordinate system in which an upper-left corner of the light receiving surface (imaging surface) is selected as an original point. The first coordinate system is determined such that the horizontal direction of the image (captured image) extends along the x-direction and the vertical direction of the image (captured image) extends along the y-direction. Thus, the position of the pixel of the captured image is represented by a set of coordinates (u, v). Notably, the horizontal direction of the captured image means a direction of a first axis of the first coordinate system, but does not mean the horizontal direction of the real space. The vertical direction of the captured image means a direction of a second axis of the first coordinate system, but does not mean the vertical direction of the real space.

Additionally, to determine a viewing direction from each of the cameras 1 and 2 to a desired area (e.g., a point P1 in FIG. 2) in the real space, a set of axes (a first axis, a third axis, and a second axis) respectively parallel to the x-direction, the y-direction and the z-direction which are mentioned above is determined for each of the cameras 1 and 2. Hence, a second coordinate system (camera coordinated system) having an original point defined by an optical center of a camera is determined for each of the cameras 1 and 2.

The second coordinate system is selected for each of the cameras 1 and 2, and has the axis (second axis) extending along the z-direction identical to an optical axis.

The viewing direction (visual direction) from the original point (optical center) O1, O2 of the second coordinate system determined for the camera 1, 2 to the point (desired point) P1 is represented by a combination of angles around the respective three axes. In the following, the angle (first angle) around the axis along the x-direction is denoted by β, and the angle (third angle) around the axis along the y-direction is denoted by α, and the angle (second angle) around the axis (optical axis) along the z-direction is denoted by φ.

In summary, the axis along the x-direction is the axis (first axis) defined by the straight line connecting the optical centers O1 and O2 of the pair of cameras 1 and 2. As for the camera 1, the axis along the z-direction is the axis (second axis) defined by the optical axis of the camera 1. As for the camera 2, the axis along the z-direction is the axis (second axis) defined by the optical axis of the camera 2. The axis along the y-direction is the axis (third axis) orthogonal to the first axis (axis along the x-direction) and the second axis (axis along the z-direction).

Data of the captured images by the respective cameras 1 and 2 is inputted into the arithmetic processing unit 10.

In the present embodiment, an example where the arithmetic processing unit 10 processes a grayscale image is described. Besides, the technical concept described below is available for an example where a color image is processed.

The arithmetic processing unit 10 includes a computer as a hardware resource, and executes a program that enables the computer to function as a device for performing a process described below. Besides, the arithmetic processing unit 10 may be a device including dedicated hardware. Alternatively, the arithmetic processing unit 10 may be constituted by a device having a function of performing a program such as a DSP (Digital Signal Processor) and a FPGA (Field-Programmable Gate Array), instead of a computer including a microcomputer.

Interposed between the camera 1 and the arithmetic processing unit 10 is an interface 3 and interposed between the camera 2 and the arithmetic processing unit 10 is an interface 4.

The interfaces 3 and 4 convert the data of the captured images by the cameras 1 and 2 into data suitable for processing by the arithmetic processing unit 10, respectively. For example, each of the interfaces 3 and 4 has a function of converting an analog signal into a digital signal.

A system program and an application program used for operating the arithmetic processing unit 10 are stored in the storage device (first storage device) 11. The data of the captured image and the data produced in the arithmetic processing which are to be processed by the arithmetic processing unit 10 are stored in the storage device (second storage device) 12 which is a data memory and a working memory.

The storage device 11 is a storage device that can retain stored information even when not powered, such as a flash memory and a hard disk drive. Further, the storage device 11 includes a volatile memory used as a main storage used for storing a system program and an application program only when the processing is performed.

The storage device 12 is not limited to a particular memory, but at least a part thereof may include a volatile memory used for working.

In the present embodiment, to obtain three-dimensional information of the real space based on the captured images respectively by the two cameras 1 and 2, the arithmetic processing unit 10 sends trigger signals to the respective interfaces 3 and 4 to allow the two cameras 1 and 2 to capture the images simultaneously. The arithmetic processing unit 10 stores the pair of captured images at the same time in the storage device 12.

With regard to each of the cameras 1 and 2, the position of the pixel on the light receiving surface is represented by the numbers of pixels in the horizontal direction and the vertical direction while the upper left corner point is determined as the original point. When a point on the optical axis projected onto the image is represented by a set of coordinates (uc, vc), a distance r between the set of coordinates (uc, vc) and a desired pixel (u, v) is represented by the following formula (1).

[FORMULA 1]

r=\sqrt{(u−uc)²+(v−vc)²} (1)

Besides, each of the cameras 1 and 2 includes the optical system that has the same or substantially the same function as a fisheye lens. Hence, it is possible to use a model in which a point in the three-dimensional real space is projected onto a spherical surface which has a radius of 1 and is centered at the optical center of the camera 1, 2.

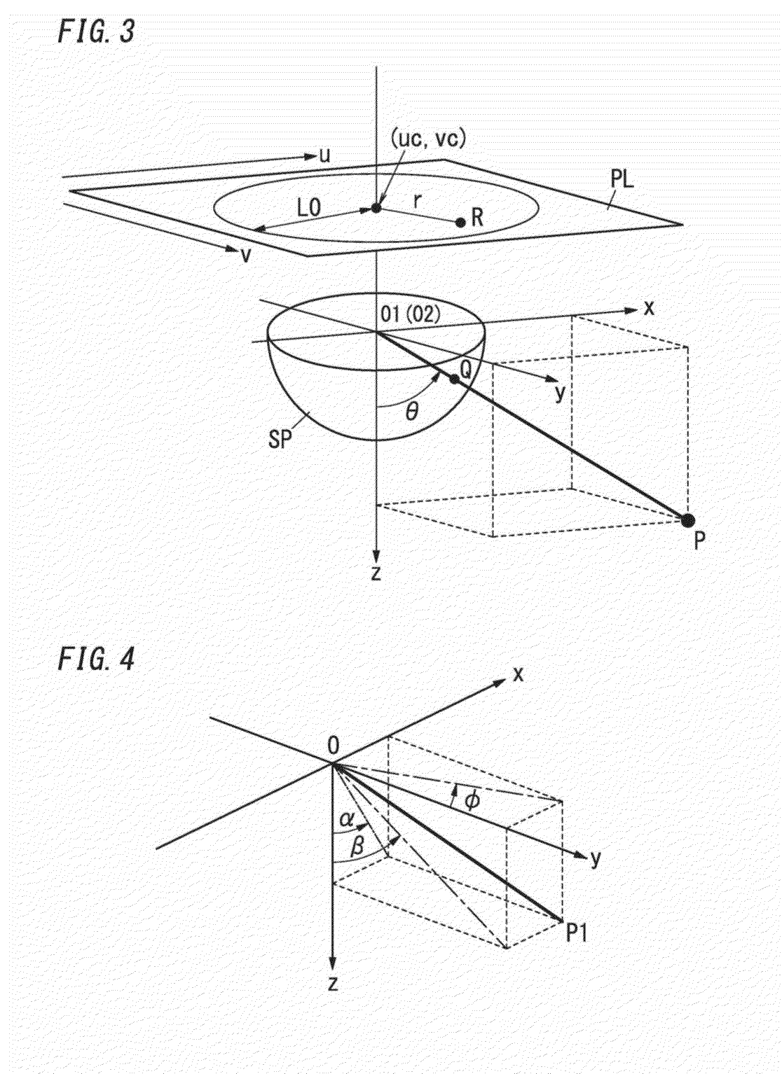

For example, equidistance projection type fisheye lenses that do not cause distortion are used as the optical systems of the cameras 1 and 2. In this case, an angle θ [rad] as shown in FIG. 3 is expressed by the following formula (2) using the distance r. The angle θ [rad] is defined as an angle between the optical axis (axis extending in the z-direction) and a straight line that connects a point Q and the optical center (original point in the second coordinate system) O1 (O2). The point Q is the projection of a point P in the real space on a spherical surface SP.

$$\begin{matrix}[ FORMULA 2 ] & \\ θ = \frac{π \cdot r}{2 \cdot L 0} & ( 2 )\end{matrix}$$

Note that, in the above formula (2), a distance L0 represents a radius of a circle which is obtained by projecting points that have Z=0 in the three-dimensional space on an image PL. A point R represents a position of a pixel that is corresponding to the projection of the point Q on the image PL.

When calibration is made such that a point in the real space is associated with a pixel at a position (u, v) in the captured image, a position of a point P1 that is the projection of a point in the real space on the spherical surface used as a model is represented by a set of coordinates (X, Y, Z). The coordinates X, Y, and Z are expressed by the following formulae (3), (4), and (5), respectively.

$$\begin{matrix}[ FORMULA 3 ] & \\ x = \frac{u - uc}{r} sin θ & ( 3 ) \\ Y = \frac{v - vc}{r} sin θ & ( 4 ) \\ Z = cos θ & ( 5 )\end{matrix}$$

As shown in FIG. 4, the position (X, Y, Z) of the point P1 can be expressed by a combination of angles around two of three axes including an x-axis, a y-axis, and a z-axis, instead of the position (u, v) of the pixel. As mentioned above, an angle around the x-axis (angle in a yz-plane) is denoted by B, and an angle around the y-axis (angle in a zx-plane) is denoted by “α”, and an angle around the z-axis (angle in a xy-plane) is denoted by φ. The angles α and β are 0 degree when the point P1 on the z-axis, and increase when the point P1 rotates counterclockwise. The angles φ is 0 degree when the point P1 on the y-axis, and increase when the point P1 rotates counterclockwise. Two different combinations of the angles (φ, β) and (α, β) are used as an alternative to the position (u, v) of the pixel. Conversion formulae to calculate the angles α, β, and φ are respectively expressed by the following formulae (6), (7), and (8) by using calculation results of the above formulae (3), (4), and (5).

$$\begin{matrix}[ FORMULA 4 ] & \\ α = {tan}^{- 1} ( \frac{X}{Z} ) & ( 6 ) \\ β = {tan}^{- 1} ( \frac{Y}{Z} ) & ( 7 ) \\ φ = {tan}^{- 1} ( \frac{X}{Y} ) & ( 8 )\end{matrix}$$

The arithmetic processing unit 10 includes a first converter 101 and a second converter 102 to create images defined by the sets of the angles (φ, β) and (α, β) in the aforementioned three-dimensional space converted from the position (u, v) of the pixel in each of the captured images respectively taken by the two cameras 1 and 2.

The first converter 101 produces an image (hereinafter referred to as “first conversion image”) in which a position of a pixel is represented by the set (φ, β) of the angle (second angle) φ around the z-axis (optical axis) and the angle (first angle) β around the x-axis. The first converter 101 is configured to convert the captured images by the pair of cameras 1 and 2 into the first conversion images. In other words, the first converter 101 converts the captured image by the first camera 1 into the first conversion image and coverts the captured image by the second camera 2 into the first conversion image. In the present embodiment, the first converter 101 creates the two first conversion images.

Additionally the second converter 102 produces an image (hereinafter referred to as “second conversion image”) in which a position of a pixel is represented by the set (α, β) of the angle (third angle) α around the y-axis and the angle (first angle) β around the x-axis. The second converter 102 is configured to convert the captured images by the pair of cameras 1 and 2 into the second conversion images. In other words, the second converter 102 converts the captured image by the first camera 1 into the second conversion image and coverts the captured image by the second camera 2 into the second conversion image. In the present embodiment, the second converter 102 creates the two second conversion images.

The angle (first angle) β is calculated by the first converter 101. When the calculation by the second converter 102 is subsequent to the calculation by the first converter 101, the second converter 102 can obtain the angle β from the first converter 101.

As the pixel value of the first conversion image, a pixel value of a pixel at a position in the receiving surface of the camera 1 or 2 that is corresponding to the position (coordinates) (φ, β) calculated by the first converter 101 is used. As the pixel value of the second conversion image, a pixel value of a pixel at a position in the receiving surface of the camera 1 or 2 that is corresponding to the position (coordinates) (α, β) calculated by the second converter 102 is used.

In summary, the first converter 101 calculates the position (coordinates) (u, v) of the pixel of the captured image from the position (coordinates) (φ, β) of the pixel of the first conversion image, and creates the first conversion image in which the pixel value of the pixel at the position (φ, β) is associated with the pixel value of the pixel of the captured image positioned at the calculated position (u, v).

Additionally, the second converter 102 calculates the position (coordinates) (u, v) of the pixel of the captured image from the position (coordinates) (α, β) of the pixel of the second conversion image, and creates the second conversion image in which the pixel value of the pixel at the position (α, β) is associated with the pixel value of the pixel of the captured image positioned at the calculated position (u, v).

To create the first conversion image and the second conversion image, the process of calculating the pixel value is performed on all of the positions (φ, β), (α, β).

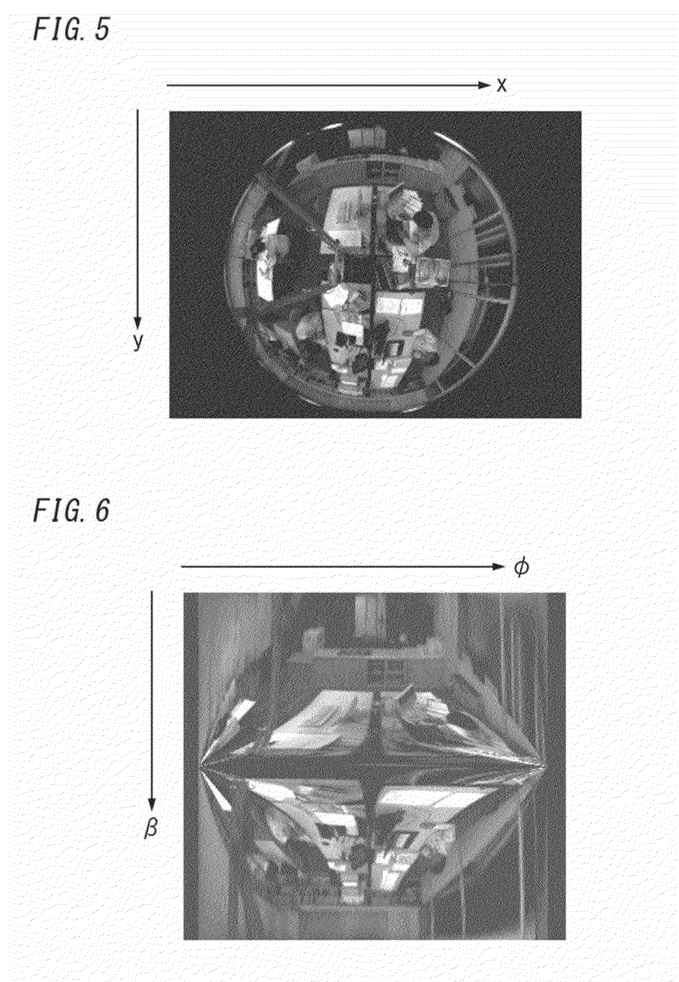

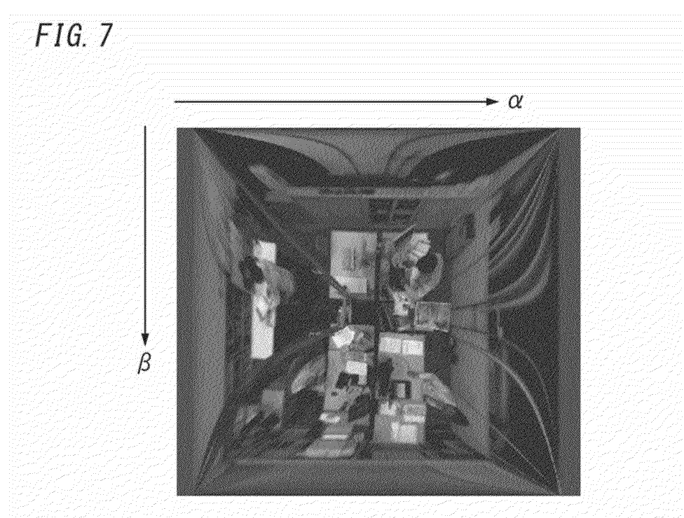

When the captured image shown in FIG. 5 is obtained, the first conversion image shown in FIG. 6 is created and the second conversion image shown in FIG. 7 is created.

FIG. 5 shows the captured image of the entire room taken by the camera 1, 2 installed in the center of the ceiling of in the room.

When the cameras 1 and 2 are installed in an aforementioned manner, as shown in FIG. 6, in the first conversion image, one region such as wall surfaces and pillars extending along the vertical direction at the opposite ends in the longitudinal direction (β-direction) is less distorted than the other region.

In contrast, as shown in FIG. 7, in the second conversion image, one region such as floor surfaces and upper surface of desks extending along the horizontal direction at the center is less distorted than the other region.

The positions (u, v) of the pixels are determined from of the positions (φ, β) and (α, β) calculated by the first converter 101 and second converter 102, respectively. However, in many cases, the position is not corresponding to one pixel only.

Hence, to calculate the pixel values of the first conversion image and the second conversion image, interpolation calculation is necessary. The interpolation calculation may be conducted with bilinear interpolation or a general algorithm such as a nearest neighbor algorithm.

The grayscale image is stored in the storage device 12. Hence, the pixel value of the position (u, v) is a luminance value and therefore the pixel values of the first conversion image and the second conversion image are also luminance values.

The first conversion images provided from the first converter 101 and the second conversion images provided from the second converter 102 are stored in the storage device 12.

The arithmetic processing unit 10 includes a disparity estimation unit 103 for estimating a disparity between the cameras 1 and 2 by use of the first conversion images and the second conversion images stored in the storage device 12.

The disparity estimation unit 103 estimates a disparity (first disparity) from the first conversion images obtained from the captured images taken by the respective cameras 1 and 2, and also estimates a disparity (second disparity) from the second conversion images. Further, the disparity estimation unit 103 determines the final disparity in view of the disparities calculated with the two different methods. The resultant disparity is used for calculation of three-dimensional information of the real space.

The disparity estimation unit 103 estimates a disparity for each pixel from the two first conversion images produced by the respective two cameras 1 and 2, and creates a single image (hereinafter referred to as “first disparity image”) having pixel values corresponding to values of the estimated disparities. Further, the disparity estimation unit 103 estimates a degree of coincidence for each pixel, and creates a single image (hereinafter referred to as “first coincidence image”) having pixel values corresponding to the estimated degrees of coincidence.

Similarly, the disparity estimation unit 103 estimates a disparity and a degree of coincidence for each pixel from the two second conversion images, and creates a single image (hereinafter referred to as “second disparity image”) having pixel values corresponding to values of the estimated disparities and a single image (hereinafter referred to as “second coincidence image”) having pixel values corresponding to the estimated degree coincidence.

To determine the disparity, the disparity estimation unit 103 uses the first disparity image and the second disparity image.

In the first conversion image, the axis extending in the vertical direction of the image is associated with the angle (first angle) β around the x-axis, and the axis extending in the horizontal direction of the image is associated with the angle (second angle) φ around the z-axis (optical axis). In the parallel stereo method, as shown in FIG. 2, when the two cameras 1 and 2 capture images of the same point (desired point) in the real space, the angles β in the first conversion images are same. Hence, to estimate the corresponding points from the two first conversion images, it is sufficient to search an area having the same angle β.

Thus, in a process of estimating the corresponding points, the disparity estimation unit 103 can narrow a search area by use of the first conversion images.

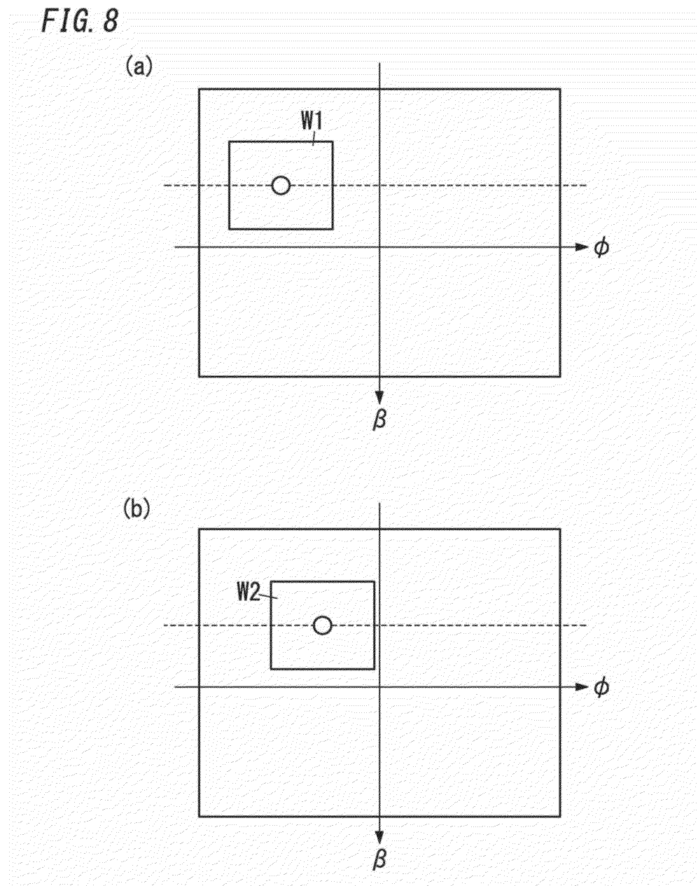

To judge whether points are the corresponding points, the disparity estimation unit 103 uses a block-matching technique. For example, as shown in FIG. 8 (a), in one first conversion image (e.g., the first conversion image associated with the first camera 1), a window W1 including a plurality of pixels is formed to surround a part to be subjected to estimation of the corresponding points. It is preferable that the window W1 is formed as a rectangular or square area surrounding a pixel to be subjected to estimation of the corresponding points.

Further, as shown in FIG. 8 (b), in the other first conversion image (e.g., the first conversion image associated with the second camera 2), a scanning area W2 having a size corresponding to the size of the window W1 is formed. The scanning area W2 is moved along the lateral axis (axis associated with the angle φ).

Since the angles β of the corresponding points in the two first conversion images are same as mentioned above, the search for the corresponding points is conducted by varying only the angle φ.

When the center position of the window W1 is a position (φL, βL) and the center position of the scanning area W2 is a position (φR, βR), the SAD value Vs is calculated with regard to a position (j, i) of a pixel in the scanning area W2 corresponding to a relative position (j, i) of a pixel in the window W1. The SAD value Vs is defined as the sum of differences (absolute values) between the pixel values (luminance values) I1 (φL+j, βL+i) and I2 (φR+j, βR+i).

In the parallel stereo method, βL is equal to βR. When a relative position of each window center is defined as (0, 0), the SAD (Sum of Absolute Difference) value Vs is expressed by the following formula (9). In this regard, the window W1 and the scanning area W2 have the same size of (2 m+1, 2n+1) (m and n are integers equal to 0 or more).

$$\begin{matrix}[ FORMULA 5 ] & \\ Vs = {\sum }_{j = - m}^{m} {\sum }_{i = - n}^{n} \vert I 1 ( φ L + j , β L + i ) - I 2 ( φ R + j , β R + i ) \vert & ( 9 )\end{matrix}$$

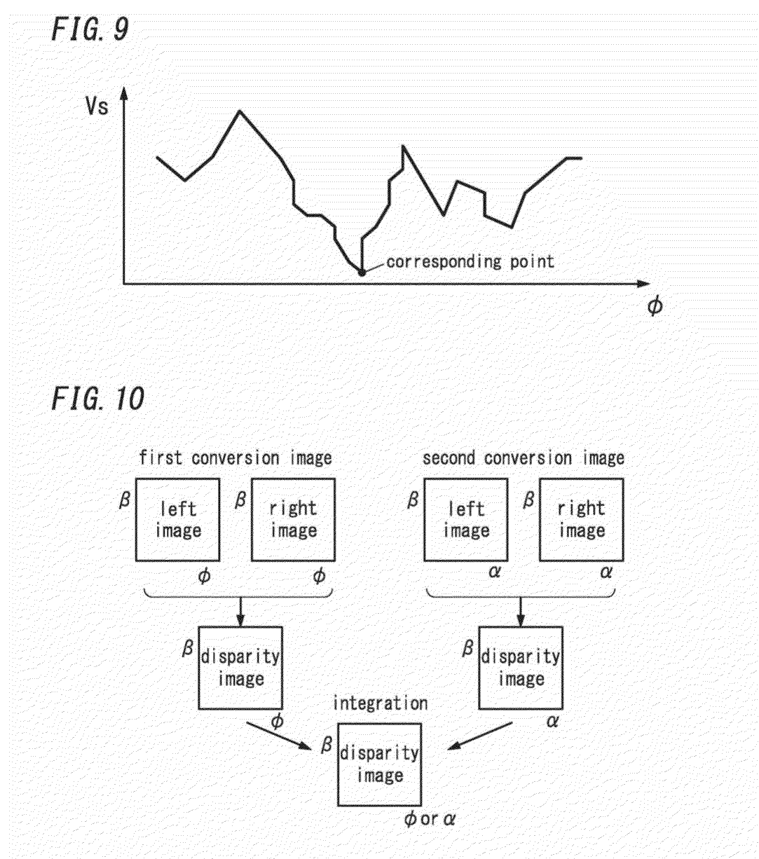

As shown in FIG. 9, the SAD value Vs changes along with movement of the scanning area W2 along the lateral axis of the first conversion image. When the scanning area W2 is positioned at a position in which the degree of coincidence between the pixel values of the pixels included in the scanning area W2 and the pixel values of the pixels included in the window W1 is high, the SAD value Vs has its minimum.

In view of this, when the SAD value Vs is equal to a prescribed threshold or less and has its minimum within the search area, the disparity estimation unit 103 determines that the center position of the scanning area W2 is the corresponding point. Note that, when the SAD value Vs has its minimum but is not equal to the threshold or less, the disparity estimation unit 103 treats the corresponding point as being undetermined.

For example, the window W1 has the center position (φL1, βL1). Further, it is assumed that the SAD value Vs is not greater than the prescribed threshold and has its minimum within the search area when the scanning area W2 has the center position (φR1. βR1).

In this case, the pixel (φR1, βR1) in the first conversion image associated with the second camera 2 is selected as the corresponding point to the pixel (φL1, βL1) in the first conversion image associated with the first camera 1.

In other words, the pixel (φL1, βL1) in the first conversion image associated with the first camera 1 is selected as the corresponding point to the pixel (φR1, βR1) in the first conversion image associated with the first camera 1.

In summary, in the present embodiment, the disparity estimation unit 103 selects arbitrarily one pixel in the first conversion image associated with the first camera 1 as the corresponding point to the desired point P1. The disparity estimation unit 103 searches the first conversion image associated with the second camera 2 for the corresponding point to the desired point P1 that is corresponding to the selected pixel.

In this manner, the disparity estimation unit 103 determines the corresponding point to the desired point P1 for each of the two first conversion images.

When obtaining the corresponding points by use of the first conversion images, the disparity estimation unit 103 calculates the disparity (first disparity) between the two cameras 1 and 2 with regard to the point (desired point) P1 by use of the coordinate positions of the corresponding points in the respective two first conversion images

When calculating the disparities, the disparity estimation unit 103 creates the first disparity image having the pixel values indicative of the disparities.

Further, the disparity estimation unit 103 calculates the degree of coincidence Ds expressed by the following formula (10), for each set of corresponding points obtained by use of the first conversion images. In other words, the disparity estimation unit 103 calculates the degree of coincidence Ds between the corresponding points of the respective two first conversion images.

The degree of coincidence Ds is calculated for all of the pixels in the first conversion image which have the corresponding points, and then the first coincidence image having the pixel values indicative of the degrees of coincidence Ds is created.

$$\begin{matrix}[ FORMULA 6 ] & \\ Ds = \frac{1}{Vs} & ( 10 )\end{matrix}$$

The disparity estimation unit 103 calculates the corresponding points from the second conversion images by use of the SAD value Vs in a similar manner as the first conversion images. With regard to the second conversion images, the disparity estimation unit 103 calculates the disparity for each set of corresponding points to create the second disparity image, and calculates the degree of coincidence Ds for each set of corresponding points to create the second coincidence image having the pixel values representing the degrees of coincidence Ds.

In summary, the disparity estimation unit 103 determines the corresponding point to the desired point P1 for each of the two second conversion images. When obtaining the corresponding points by use of the second conversion images, the disparity estimation unit 103 calculates the disparity (second disparity) between the two cameras 1 and 2 with regard to the point (desired point) P1 by use of the coordinate positions of the corresponding points in the respective two second conversion images. When calculating the disparities, the disparity estimation unit 103 creates the second disparity image having the pixel values indicative of the disparities.

Further, the disparity estimation unit 103 calculates the degree of coincidence Ds expressed by the above formula (10), for each set of corresponding points obtained by use of the second conversion images. In other words, the disparity estimation unit 103 calculates the degree of coincidence Ds between the corresponding points of the respective two second conversion images.

The first disparity image and the first coincidence image as well as the second disparity image and the second coincidence image are stored in the storage device 12.

Next, the disparity estimation unit 103 determines the disparity by use of the first disparity image and the second disparity image. To determine the disparity, the disparity estimation unit 103 extracts, from the second disparity image, the pixels respectively corresponding to the pixels of the first disparity image, and judges whether the corresponding pixels have the pixel values (disparities).

The disparity estimation unit 103 extracts from the second disparity image the pixel corresponding to the pixel of the first disparity image by use of the following equations. For example, when the position of the pixel of the first disparity image is represented as (φ1, β1), the position of the corresponding pixel of the second disparity image is represented as (α2, β2). In this case, α2 and β2 are respectively represented by the following formulae (11) and (12).

[FORMULA 7]

α2=tan⁻¹(tan φ1·tan β1) (11)

β2=β1 (12)

The disparity estimation unit 103 evaluates a degree of reliability of a pixel value for each pixel value by use of the first coincidence image and the second coincidence image, provided that the corresponding pixels of the first disparity image and the second disparity image have the pixel values.

For example, it is assumed that the position (φ1, β1) in the first disparity image and the position (α2, β2) in the second disparity image have the pixel values (disparities). In this case, the disparity estimation unit 103 compares the pixel value (degree of coincidence) of the position (φ1, β1) in the first coincidence image with the pixel value (degree of coincidence) of the position (α2, β2) in the second coincidence image.

When the degree of coincidence of the first coincidence image is greater than the degree of coincidence of the second coincidence image, the disparity estimation unit 103 selects the pixel value of the position (φ1, β1) in the first disparity image as the disparity, and updates the pixel value of the position (α2, β2) in the second disparity image as an undetermined value.

Similarly, when the degree of coincidence of the second coincidence image is greater than the degree of coincidence of the first coincidence image, the disparity estimation unit 103 selects the pixel value of the position (α2, β2) in the second disparity image as the disparity, and updates the pixel value of the position (φ1, β1) in the first disparity image as an undetermined value.

When the degrees of coincidence are the same, the disparity estimation unit 103 selects as the disparity an average or one of the pixel values of the position (φ1, β1) in the first disparity image and the position (α2, β2) in the second disparity image.

When one of the position (φ1, β1) in the first disparity image and the position (α2, β2) in the second disparity image has the pixel value (disparity), the disparity estimation unit 103 selects this pixel value as the disparity.

When the corresponding pixels of the first disparity image and the second disparity image have no pixel values, the disparity estimation unit 103 concludes that the disparity at the selected position is undetermined.

By performing the aforementioned process, the pixel value (disparity) of one that has the higher degree of reliability (i.e., the degree of coincidence) of the first disparity image and the second disparity image is selected for each pixel. Hence, by calculating the three-dimensional position in the real space by use of the selected pixel values, it is possible to obtain the three-dimensional information that is highly reliable.

FIG. 10 shows a schematic diagram illustrating the operation of the stereo camera device of the present embodiment. According to this diagram, the two first conversion images (images each defined by β and φ) and the two second conversion images (images each defined by β and α) are obtained from the two captured images created by the left and right cameras 1 and 2. Thereafter, the disparity image (first disparity image) is derived from the two first conversion images and the disparity image (second disparity image) is obtained from the two second conversion images. With integration of the two resultant disparity images, the single disparity image is obtained.

The stereo camera device of the present embodiment described above includes the plurality of cameras 1 and 2, and the arithmetic processing unit 10. The plurality of cameras 1 and 2 are arranged such that optical axes thereof are parallel to each other and the fields of view thereof are overlapped with each other. To calculate the three-dimensional information of a part (desired part) P1 in the field of view from the plurality of captured images respectively taken by the cameras 1 and 2, the arithmetic processing unit 10 calculates the disparity regarding the part (desired point) P1. In the stereo camera device of the present embodiment, the first coordinate system and the second coordinate system are used. The first coordinate system is a coordinate system defined such that a position of a pixel of the captured image is determined by the two-dimensional orthogonal coordinates defined in the light receiving surface, for each of the cameras 1 and 2. The second coordinate system is a coordinate system defined such that the viewing direction (i.e., the visual direction of the camera 1, 2) from the original point (optical center) O1 (O2) to the part (desired point) P1 is represented by the angles respectively around the three axes defined by the first direction, the second direction, and the third direction, for each camera 1 (2). The first direction is a direction in which the optical centers O1 and O2 of the two cameras 1 and 2 selected from the plurality of cameras 1 and 2 are straightly connected to each other. The second direction is the direction along the optical axis for each camera 1 (2). The third direction is perpendicular to the first direction and the second direction. The arithmetic processing unit 10 includes the first converter 101, the second converter 102, and the disparity estimation unit 103. The first converter 101 is configured to convert the captured image into the first conversion image in which the position in the vertical direction is represented by the angle β around the axis in the first direction and the position in the horizontal direction is represented by the angle φ around the axis in the second direction. The second converter 102 is configured to convert the captured image into the second conversion image in which the position in the vertical direction is represented by the angle β around the axis in the first direction and the position in the horizontal direction is represented by the angle α around the axis in the third direction. The disparity estimation unit 103 is configured to calculate the disparity regarding the part (desired point) P1 by associating the parts (desired points) in the fields of view of the two cameras 1 and 2 by use of the first conversion images and the second conversion images.

In other words, the stereo camera device of the present embodiment includes the stereo camera unit 13; and the arithmetic processing unit 10. The stereo camera unit 13 includes the pair of cameras 1 and 2 for capturing images of a predetermined space, and is configured to provide the captured images respectively by the pair of cameras 1 and 2 to the arithmetic processing unit 10. The arithmetic processing unit 10 includes the first converter 101, the second converter 102, and the disparity estimation unit 103. The first converter 101 is configured to convert the captured image by the camera 1 (2) into the first conversion image for each of the pair of cameras 1 and 2. The first conversion image is defined as an image in which a position of a pixel is represented by two-dimensional orthogonal coordinates defined by the first angle β around the first axis and the second angle φ around the second axis. The second converter 102 is configured to convert the captured image by the camera 1 (2) into the second conversion image for each of the pair of cameras 1 and 2. The second conversion image is defined as an image in which a position of a pixel is represented by two-dimensional orthogonal coordinates defined by the first angle β and the third angle α around the third axis. The first axis is defined by a straight line connecting optical centers O1 and O2 of the pair of cameras 1 and 2 to each other. The second axis is defined by the optical axis of the camera 1 (2). The third axis is defined by an axis respectively orthogonal to the first axis and the second axis. The disparity estimation unit 103 is configured to calculate the disparity regarding the desired point P1 in the space based on the first conversion images obtained by the first converter 101 and the second conversion images obtained by the second converter 102.

The stereo camera device of the present embodiment mentioned above uses the conversion images (the first conversion image and the second conversion image) obtained by performing coordinate conversion on the images captured by the cameras 1 and 2 such that a straight line parallel to the optical axis is not distorted. There are advantageous effects that associating the images captured by the two cameras 1 and 2 is facilitated.

Further in the stereo camera device of the present embodiment, the disparity estimation unit 103 calculates the disparity regarding the part P1 by obtaining the corresponding points in the two first conversion images respectively created from the captured images taken by the two cameras 1 and 2, and estimates the degree of coincidence between the corresponding points. Additionally, the disparity estimation unit 103 calculates the disparity regarding the part P1 by obtaining the corresponding points in the two second conversion images respectively created from the captured images taken by the cameras 1 and 2, and estimates the degree of coincidence between the corresponding points. The disparity estimation unit 103 selects, as the disparity regarding the part P1, a disparity that has the higher degree of coincidence from the disparities of the pixels related to the same part P1 included in the disparities calculated for each of the pixels in the first conversion image and the second conversion image.

In other words, the disparity estimation unit 103 is configured to calculate the corresponding points regarding the desired point P1 from the two first conversion images respectively corresponding to the pair of cameras 1 and 2, and calculate the disparity (first disparity) regarding the desired point P1 based on the corresponding points, and evaluate the degree of coincidence (first degree of coincidence) Ds between the corresponding points of the two first conversion images. The disparity estimation unit 103 is configured to calculate the corresponding points regarding the desired point P1 from the two second conversion images respectively corresponding to the pair of cameras 1 and 2, and calculate the disparity (second disparity) regarding the desired point P1 based on the corresponding points, and evaluate the degree of coincidence (second degree of coincidence) Ds between the corresponding points of the two second conversion images. The disparity estimation unit 103 is configured to compare the first degree of coincidence Ds with the second degree of coincidence Ds with regard to the same desired point P1, and select the first disparity as the disparity regarding the desired point P1 when the first degree of coincidence Ds is higher than the second degree of coincidence Ds, and select the second disparity as the disparity regarding the desired point when the first degree of coincidence Ds is lower than the second degree of coincidence Ds.

Note that, in the present embodiment, the block-matching technique is employed. However, the technique for calculating the pixel values of the first disparity image and the second disparity image is not limited to the block-matching technique but may be another technique available for stereo matching.

Optionally, the stereo camera device of the present embodiment further includes a distance measurement unit (not shown). The distance measurement unit is configured to calculate a distance to the desired point P1 by use of the disparity calculated by the disparity estimation unit 103. The distance measurement unit may be configured to calculate the distances to a plurality of desired points P1 to create a distance image.

As described above, in the present embodiment, the position in the horizontal directions of the first conversion images are represented by the angles (second angles) φ around the optical axes of the cameras 1 and 2, respectively. According to the first conversion images, it is possible to associate straight lines parallel to the optical axes with each other without causing distortion. Hence, by using the first conversion images, it is possible to facilitate stereo matching regarding planes parallel to the optical axes. Additionally, the disparity is calculated from not only the first conversion images but also the second conversion images, and the accuracies of the disparities of the first conversion image and the second conversion image are evaluated by use of the degrees of coincidence. Consequently, it is possible to estimate the disparity with the accuracy higher than that of the prior art.

The program for operating the computer is used for a stereo camera device. The stereo camera device includes the plurality of cameras 1 and 2. The plurality of cameras 1 and 2 are arranged such that optical axes thereof are parallel to each other and the fields of view thereof are overlapped with each other. To calculate the three-dimensional information of a part (desired part) P1 in the field of view from the plurality of captured images respectively taken by the cameras 1 and 2, the stereo camera device calculates the disparity regarding the part (desired point) P1. In the stereo camera device, the first coordinate system and the second coordinate system are used. The first coordinate system is a coordinate system defined such that a position of a pixel of the captured image is determined by the two-dimensional orthogonal coordinates defined in the light receiving surface, for each of the cameras 1 and 2. The second coordinate system is a coordinate system defined such that the viewing direction (i.e., the visual direction of the camera 1, 2) from the original point (optical center) O1 (O2) to the part (desired point) P1 is represented by the angles respectively around the three axes defined by the first direction, the second direction, and the third direction, for each camera 1 (2). The first direction is a direction in which the optical centers O1 and O2 of the two cameras 1 and 2 selected from the plurality of cameras 1 and 2 are straightly connected to each other. The second direction is the direction along the optical axis for each camera 1 (2). The third direction is perpendicular to the first direction and the second direction. This program allows the computer to functions as the first converter 101, the second converter 102, and the disparity estimation unit 103. The first converter 101 is configured to convert the captured image into the first conversion image in which the position in the vertical direction is represented by the angle β around the axis in the first direction and the position in the horizontal direction is represented by the angle φ around the axis in the second direction. The second converter 102 is configured to convert the captured image into the second conversion image in which the position in the vertical direction is represented by the angle β around the axis in the first direction and the position in the horizontal direction is represented by the angle α around the axis in the third direction. The disparity estimation unit 103 is configured to calculate the disparity regarding the part (desired point) P1 by associating the parts (desired points) in the fields of view of the two cameras 1 and 2 by use of the first conversion images and the second conversion images.

Besides, this program may be recorded on a computer-readable recording medium. This computer-readable recording medium is defined as a computer-readable recording medium storing a program used in a computer connected to a stereo camera unit. The stereo camera unit 13 includes the pair of cameras 1 and 2 for capturing images of the predetermined space, and is configured to provide the captured images respectively by the pair of cameras 1 and 2 to the arithmetic processing unit 10. The pair of cameras 1 and 2 are arranged such that optical axes thereof are parallel to each other and fields of view thereof are overlapped with each other. The program is designed to have the computer functions the first converter 101, the second converter 102, and the disparity estimation unit 103. The first converter 101 is configured to convert the captured image by the camera 1 (2) into the first conversion image for each of the pair of cameras 1 and 2. The first conversion image is defined as an image in which a position of a pixel is represented by two-dimensional orthogonal coordinates defined by the first angle β around the first axis and the second angle φ around the second axis. The second converter 102 is configured to convert the captured image by the camera 1 (2) into the second conversion image for each of the pair of cameras 1 and 2. The second conversion image is defined as an image in which a position of a pixel is represented by two-dimensional orthogonal coordinates defined by the first angle β and the third angle α around the third axis. The first axis is defined by a straight line connecting optical centers O1 and O2 of the pair of cameras 1 and 2 to each other. The second axis is defined by the optical axis of the camera 1 (2). The third axis is defined by an axis respectively orthogonal to the first axis and the second axis. The disparity estimation unit 103 is configured to calculate the disparity regarding the desired point P1 in the space based on the first conversion images obtained by the first converter 101 and the second conversion images obtained by the second converter 102.

### Second Embodiment

In the first embodiment, the disparity estimation unit 103 searches for the corresponding points by use of the block-matching technique. Further, search for the corresponding points is performed on each of the first conversion image and the second conversion image. In the following explanation, when there is no need to distinguish the first conversion image and the second conversion image from each other, they are simply referred to as conversion images.

In the block-matching, as shown in FIG. 8, the window W1 is set to one conversion image to be searched for the corresponding point and the scanning area W2 is set to the other conversion image. Further, in the latter conversion image, the scanning area W2 is moved along the lateral axis. The position of the scanning area W2 at which the SAD value Vs defined by the aforementioned formula (9) is minimized is determined as the corresponding point.

In this block-matching, if the SAD value Vs hardly changes along with change in the position of the scanning area W2 in the conversion image, the corresponding points cannot be obtained. This problem is likely to occur if change in the distribution of the luminance value is small in the lateral direction of the conversion image. For example, a strip area along the lateral direction is present in the conversion image, and the luminance in this area is not changed in the lateral direction. In this case, it is impossible to determine the corresponding points.

As described in the first embodiment, the distortion in the direction parallel to the optical axis of the camera is reduced at the opposite ends in the longitudinal direction of the first conversion image. The distortion in the plane perpendicular to the optical axis of the camera is reduced at the center of the second conversion image.

As the distortion is reduced, the search for the corresponding points is more facilitated and the reliability is more increased. Hence, for each pixel to be searched for the corresponding points, there may be two cases where the pixel of the first conversion image is suitable for the search for the corresponding points and the pixel of the second conversion image is suitable for the search for the corresponding points.

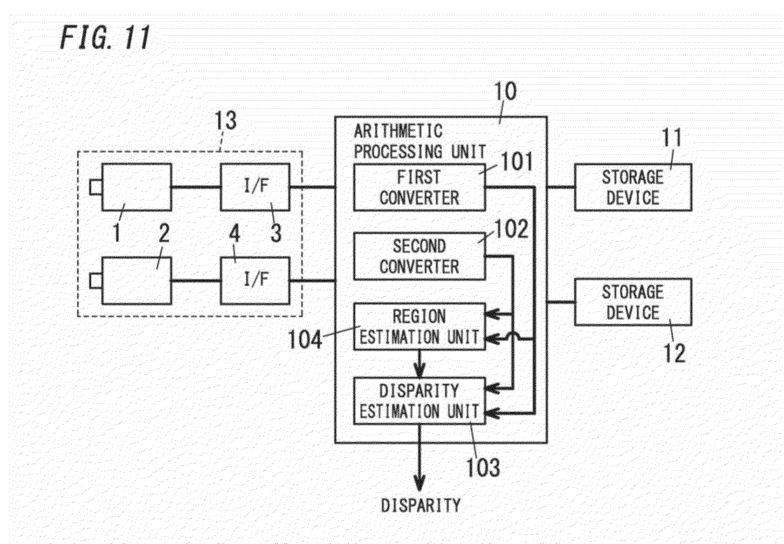

In the present embodiment, to evaluate which one of the first conversion image and the second conversion image is suitable for the search for the corresponding points before the disparity estimation unit 103 searches for the corresponding points, a region evaluation unit 104 is added as shown in FIG. 11. In other words, in the present embodiment, the arithmetic processing unit 10 further includes the region evaluation unit 104.

The region evaluation unit 104 evaluates whether an intended region is a prescribed region in which change in the luminance value in the lateral direction is relatively large, for each of the first conversion image and the second conversion image.

In view of the evaluation result obtained by the region evaluation unit 104, the disparity estimation unit 103 uses at least one of the first conversion image and the second conversion image to search for the corresponding points.

As the process prior to the process by the disparity estimation unit 103, the evaluation is made by the region evaluation unit 104 to reduce the number of objects to be searched for the corresponding points. Hence, the number of unprofitable processes can be reduced. Consequently, a computational complexity can be reduced and the reliability of the stereo matching can be improved.

To evaluate change in the luminance value in the lateral direction for each of the conversion images (the first conversion image and the second conversion image) obtained from the same captured image, the region evaluation unit 104 uses an edge intensity E1 defined by the following formula (13) as an evaluation value for the pixel (φ, β) of the first conversion image. Additionally, the region evaluation unit 104 uses an edge intensity E2 defined by the following formula (14) as an evaluation value for the pixel (α, β) of the second conversion image. The edge intensity E1 is calculated from the first conversion image and the edge intensity E2 is calculated from the second conversion image.

[FORMULA 8]

E1=|I1(φ−1,β)−I1(φ+1,β)| (13)

E2=|I2(α−1,β)−I2(α+1,β)| (14)

Note that, I1(φ. β) denotes the luminance value (pixel value) of the position (φ, β) in the first conversion image, and 12 denotes the luminance value (pixel value) of the position (α, β) in the second conversion image. In other words, the region evaluation unit 104 calculates the first evaluation value (edge intensity) E1 regarding the change in the luminance value for the pixel (first pixel) (φ, β) of the first conversion image, and the second evaluation value (edge intensity) E2 regarding the change in the luminance value for the pixel (second pixel) (α, β) of the second conversion image.

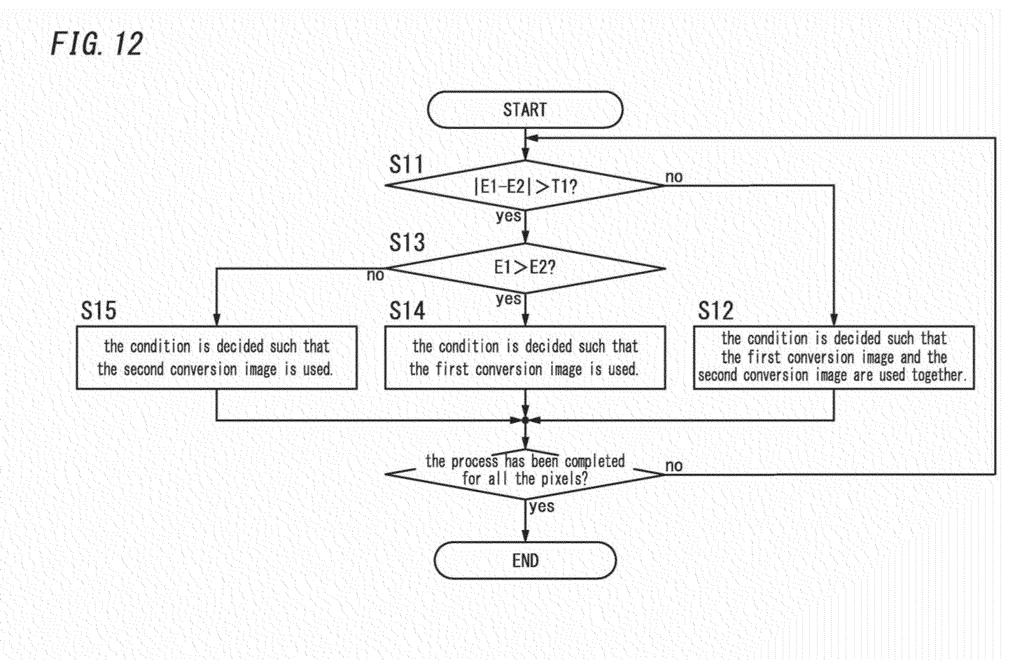

As shown in FIG. 12, the region evaluation unit 104 performs the following evaluation on all the pixels of each of the first conversion image and the second conversion image, thereby determining, for each pixel, which one of the first conversion image and the second conversion image is used by the disparity estimation unit 103 to search for the corresponding points.

In the operation shown in FIG. 12, the region evaluation unit 104 calculates the edge intensity E1 with regard to the pixel (φ, β) of the first conversion image and also calculates the edge intensity E2 with regard to the pixel (α, β) of the second conversion image corresponding to the above pixel (φ, β). Note that, the pixel of the second conversion image corresponding to the pixel (φ, β) of the first conversion image means the pixel of the second conversion image that is derived from the same pixel of the captured image from which the pixel of the first conversion image is derived. For example, if the pixel (φ1, β1) of the first conversion image and the pixel (α2, β2) of the second conversion image are derived from the same pixel (u0, v0) of the captured image, the pixel (φ1, β1) of the first conversion image and the pixel (α2, β2) of the second conversion image are pixels corresponding to each other. In other words, the edge intensity E1 is calculated from the luminance values of pixels on both sides of the selected pixel in the lateral direction with regard to the first conversion image, and the edge intensity E2 is calculated from the luminance values of pixels on both sides of the selected pixel in the lateral direction with regard to the second conversion image.

Next, an absolute value of a difference between the edge intensity E1 calculated from the first conversion image and the edge intensity E2 calculated from the second conversion image is compared with a predetermined threshold T1 (S11). In other words, the region evaluation unit 104 calculates the difference |E1−E2 | between the first evaluation value E1 and the second evaluation value E2 and compares the difference |E1-E2| with the threshold T1.

When the absolute value of the difference between the edge intensities E1 and E2 is not greater than the threshold T1, the reliability of the disparity calculated from the first conversion image and the reliability of the disparity calculated from the second conversion image are probably in a similar range.

For this reason, when the absolute value of the difference between the edge intensities E1 and E2 is not greater than the threshold T1 (S11: no), to search for the corresponding points regarding the desired pixel, it is scheduled to use both the first conversion images and the second conversion images (S12). In other words, the region evaluation unit 104 selects a third condition for the first pixel (φ, β) and the second pixel (α, β) when the difference |E1-E2| is equal to the threshold T1 or less. When the third condition is selected for the first pixel (φ, β) and the second pixel (α, β), the region evaluation unit 104 calculates the corresponding points by use of the first conversion images and the second conversion images with regard to the first pixel (φ, β) and the second pixel (α, β).

In contrast, when the absolute value of the difference between the edge intensities E1 and E2 is greater than the threshold T1 (S11: yes), the edge intensities E1 and E2 are compared with each other (S13). In other words, when the difference |E1−E2| exceeds the threshold T1, the region evaluation unit 104 compares the change in the luminance value of the first pixel (φ, β) (in the present embodiment, the edge intensity E1) and the change in the luminance value of the second pixel (α, β) (in the present embodiment, the edge intensity E2).

Probably, as the edge intensity E1, E2 is greater, the search for the corresponding points is facilitated more. Hence, when the edge intensity E1 is greater than the edge intensity E2 (S13: yes), to search for the corresponding points regarding the desired pixel, a condition is determined such that the first conversion images are searched for the corresponding points (S14). In other words, when the change in the luminance value of the first pixel (φ, β) (the edge intensity E1) exceeds the change in the luminance value of the second pixel (α, β) (the edge intensity E2), the region evaluation unit 104 selects a first condition for the first pixel (φ, β) and the second pixel (α, β). When the first condition is selected for the first pixel (φ, β) and the second pixel (α, β), the region evaluation unit 104 calculates the corresponding points by use of the first conversion images with regard to the first pixel (φ, β) and the second pixel (α, β).

In contrast, when the edge intensity E1 is less than the edge intensity E2 (S13: no), to search for the corresponding points regarding the desired pixel, a condition is determined such that the second conversion images are searched for the corresponding points (S15). In other words, when the change in the luminance value of the first pixel (φ, β) (the edge intensity E1) falls below the change in the luminance value of the second pixel (α, β) (the edge intensity E2), the region evaluation unit 104 selects a second condition for the first pixel (φ, β) and the second pixel (α, β). When the second condition is selected for the first pixel (φ, β) and the second pixel (α, β), the region evaluation unit 104 calculates the corresponding points by use of the second conversion images with regard to the first pixel (φ, β) and the second pixel (α, β).

The aforementioned process is performed on all the pixels in the first conversion image (S16). Further, the evaluation result from the region evaluation unit 104 is provided to the disparity estimation unit 103 by way of the storage device 12 connected to the arithmetic processing unit 10.

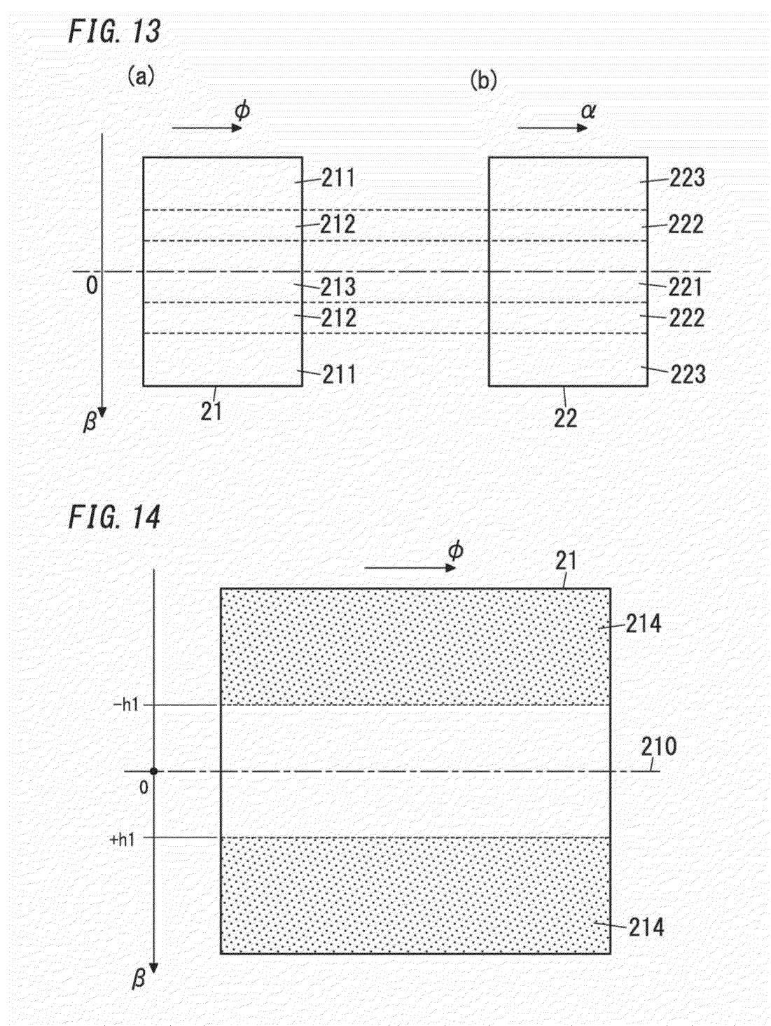

When classification of regions to be searched for the corresponding points is performed with the process shown in FIG. 12, the first conversion image 21 is divided into regions 211, regions 212, and a region 213, as shown in FIG. 13 (a). In the region 211, only the first conversion images 21 are used. In the region 212, both the first conversion images 21 and the second conversion images 22 are used. The region 213 is not used to search for the corresponding points. Similarly, the second conversion image 22 is divided into a region 221, regions 222, and regions 223, as shown in FIG. 13 (b). In the region 221, only the second conversion images 22 are used. In the region 222, both the first conversion images 21 and the second conversion images 22 are used. The region 223 is not used to search for the corresponding points.

The stereo camera device of the present embodiment described above includes the region evaluation unit 104. The region evaluation unit 104 calculates the evaluation values regarding a change in the surrounding luminance values with regard to the first conversion images and the second conversion images for each intended pixel. The region evaluation unit 104 is configured to, when the difference between the evaluation values exceeds the threshold T1, determine a condition such that the conversion images that have the greater change in the luminance value are selected among the first conversion images and the second conversion images and used for extracting the corresponding points to the intended pixel. The region evaluation unit 104 is configured to, when the difference between the evaluation values falls below the threshold T1, determine a condition such that both the first conversion images and the second conversion images are used for extracting the corresponding points to the intended pixel. The disparity estimation unit 103 is configured to obtain the corresponding points for each pixel in conformity with the condition determined by the region evaluation unit 104.

In other words, in the stereo camera device of the present embodiment, the arithmetic processing unit 10 further includes the region evaluation unit 104. The region evaluation unit 104 is configured to calculate the first evaluation value (edge intensity) E1 regarding a change in the luminance value with regard to the first pixel (φ, β) of the first conversion image and the second evaluation value (edge intensity) E2 regarding a change in the luminance value with regard to the second pixel (α, β) of the second conversion image corresponding to the first pixel (φ, β). The region evaluation unit 104 is configured to calculate the difference |E1-E2| between the first evaluation value E1 and the second evaluation value E2 and compare the difference |E1−E2| with the predetermined threshold T1. The region evaluation unit 104 is configured to compare the change in the luminance value of the first pixel (φ, β) (the edge intensity E1 in the present embodiment) and the change in the luminance value of the second pixel (α, β) (the edge intensity E2 in the present embodiment) when the difference |E1−E2 | exceeds the threshold T1. The region evaluation unit 104 is configured to select a first condition for the first pixel (φ, β) and the second pixel (α, β) when the change in the luminance value of the first pixel (φ, β) (the edge intensity E1) exceeds the change in the luminance value of the second pixel (α, β) (the edge intensity E2). The region evaluation unit 104 is configured to select a second condition for the first pixel (φ, β) and the second pixel (α, β) when the change in the luminance value of the first pixel (φ, β) (the edge intensity E1) falls below the change in the luminance value of the second pixel (α, β) (the edge intensity E2). The region evaluation unit 104 is configured to select a third condition for the first pixel (φ, β) and the second pixel (α, β) when the difference |E1-E2| is equal to the threshold T1 or less. The region evaluation unit 104 is configured to, when the first condition is selected for the first pixel (φ, β) and the second pixel (α, β), calculate the corresponding points by use of the first conversion images with regard to the first pixel (φ, β) and the second pixel (α, β). The region evaluation unit 104 is configured to, when the second condition is selected for the first pixel (φ, β) and the second pixel (α, β), calculate the corresponding points by use of the second conversion images with regard to the first pixel (φ, β) and the second pixel (α, β). The region evaluation unit 104 is configured to, when the third condition is selected for the first pixel (φ, β) and the second pixel (α, β), calculate the corresponding points by use of the first conversion images and the second conversion images with regard to the first pixel (φ, β) and the second pixel (α, β).

In the present embodiment, before the disparity estimation unit 103 performs the process of searching for the corresponding points and calculating the disparity, the region evaluation unit 104 decides the condition determining which one of the pair of first conversion images and the pair of second conversion images is used for calculating the corresponding points. Hence, in the first conversion images and the second conversion images, the region used for calculation of the disparity is narrowed. In summary, in contrast to a case where the corresponding points are calculated for all the regions of each of the first conversion images and the second conversion images, a computational complexity is reduced. Further, since pixels used for search for the corresponding points are selected from the first conversion images and the second conversion images to improve as possible the reliability of the disparity calculated for each pixel, the reliability of the calculated disparity is improved.

In the aforementioned operation, the edge intensities E1 and E2 are calculated from the pixels adjacent to the intended pixel in the lateral direction. However, an alternative technique (e.g., the Sobel operator) used in the image processing techniques for calculating an edge intensity or a gradient direction of a luminance value may be available. The other configurations and operations are the same as those of the first embodiment.

### Third Embodiment

Since in the first embodiment, the first converter 101 and the second converter 102 perform the conversion of the captured images with regard to all the pixels in each of the images captured by the cameras 1 and 2, the computational complexity is relatively large. In the present embodiment, an explanation is made to a technique of reducing the computational complexity by preliminarily limiting regions of the captured images to be converted by the first converter 101 and the second converter 102.

Each of the first converter 101 and the second converter 102 has a function of converting the coordinates and a function of associating the luminance value with the coordinate obtained by the conversion. Since the conversion of the coordinates is performed by use of the above formulae (1) to (8), some of the conversion can be easily performed by use of look-up tables. However, the process of associating the luminance value with the coordinates obtained by the conversion requires reverse conversion, thereby causing an increase in the computational complexity.

In view of this, as shown in FIG. 14, the first converter 101 performs the process of associating the luminance value with regard to a region 214 which satisfies a condition (first decision condition) that the angle β from a center line 210 at β=0 in the first conversion image 21 is not less than a prescribed threshold h1 (e.g., h1=30 degrees). In summary, the first converter 101 performs the process of determining the pixel value (luminance value) with regard to only the region 214 in the first conversion image 21 which satisfies the relation of |β|≧h1.

In other words, the first converter 101 is configured to decide a first extraction region (region 214) used for extracting the corresponding point from the first conversion image in accordance with the predetermined first decision condition, and calculate a pixel value regarding a pixel included in the first extraction region (region 214), and not calculate a pixel value regarding a pixel not included in the first extraction region (region 214).

To associate the luminance values with the respective pixels in the first conversion images, the process of calculating the position (u, v) in the images captured by the cameras 1 and 2 from the position (φ, β) of the pixel in the first conversion image is necessary. Further, it is necessary to determine the luminance value with the interpolation using the luminance values of pixels surrounding the calculated position (u, v). Consequently, the process of associating the luminance value with the pixel in the first conversion image requires the more computational complexity than the process of converting the position (u, v) in the captured image taken into the position (φ, β) of the pixel in the first conversion image does. In contrast, in the present embodiment, the region associated with the luminance values is narrowed. Hence, the computational complexity can be reduced.

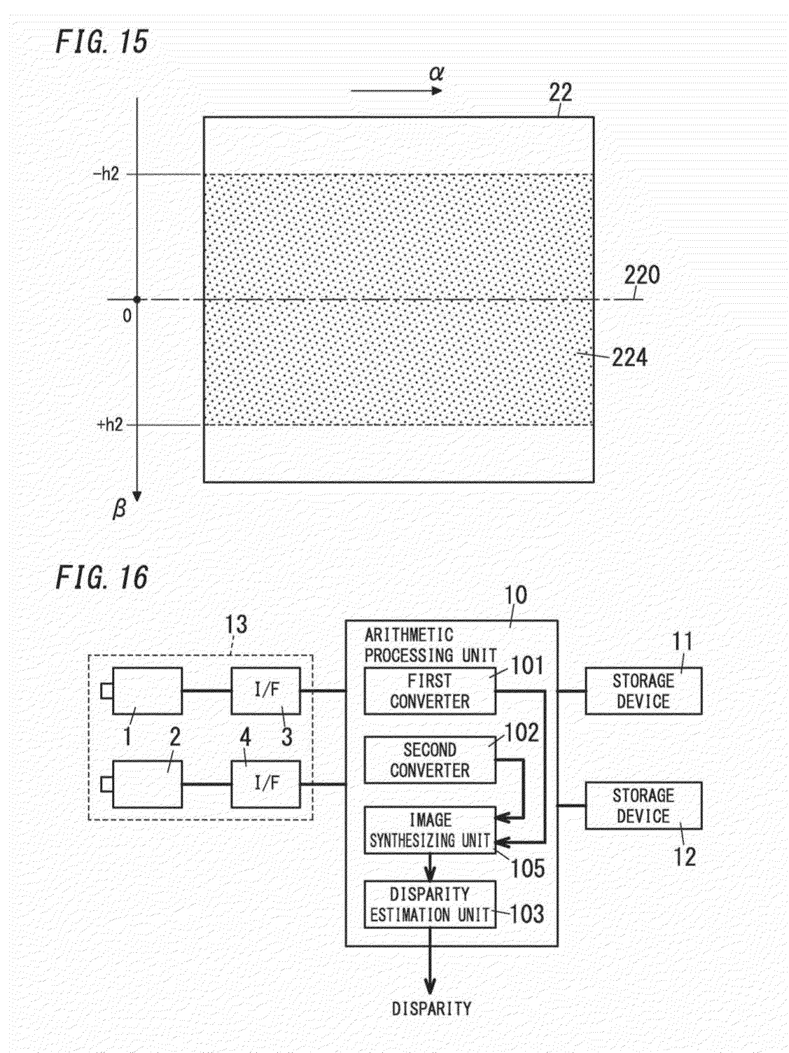

Similarly, as shown in FIG. 15, the second converter 102 performs the process of associating the luminance value with regard to a region 224 which satisfies a condition (second decision condition) that an angle β from a center line 220 at β=0 in the second conversion image 22 is not greater than a prescribed threshold h2 (e.g., h2=60 degrees). In summary, the second converter 102 performs the process of determining the pixel value (luminance value) with regard to only the region 224 in the second conversion image 22 which satisfies the relation of |β|≦h2.

In other words, the second converter 102 is configured to decide a second extraction region (region 224) used for extracting the corresponding point from the second conversion image in accordance with the predetermined second decision condition, and calculate a pixel value regarding a pixel included in the second extraction region (region 224), and not calculate a pixel value regarding a pixel not included in the second extraction region (region 224).

Thus, also with regard to the second conversion image 22, the region associated with the luminance values is narrowed. Hence, the computational complexity can be reduced.

The present embodiment is the same as the first embodiment except that each of the first conversion image 21 and the second conversion image 22 relates to a partial area. After the first conversion image 21 and the second conversion image 22 are obtained, the process of obtaining the first disparity image and the first coincidence image as well as the second disparity image and the second coincidence image, and of determining the disparity is performed.

As described above, in the stereo camera device of the preset embodiment, with regard to a first region in which the corresponding points are determined by use of either the first conversion image or the second conversion image and a second region in which the corresponding points are determined by use of both the first conversion image and the second conversion image, the first converter 101 and the second converter 102 have functions of determining at least the first region in conformity with a predetermined condition with respect to the first conversion image and the second conversion image.

In other words, in the stereo camera device of the present embodiment, the first converter 101 is configured to decide a first extraction region (region 214) used for extracting the corresponding point from the first conversion image in accordance with the predetermined first decision condition, and calculate a pixel value regarding a pixel included in the first extraction region (region 214), and not calculate a pixel value regarding a pixel not included in the first extraction region (region 214). The second converter 102 is configured to decide a second extraction region (region 224) used for extracting the corresponding point from the second conversion image in accordance with the predetermined second decision condition, and calculate a pixel value regarding a pixel included in the second extraction region (region 224), and not calculate a pixel value regarding a pixel not included in the second extraction region (region 224).

The thresholds h1 and h2 described in the present embodiment are only examples, and these thresholds h1 and h2 may be appropriately set. Particularly, when there is no need to calculate the disparity for the entire captured image, a region to be associated with the luminance value may be more narrowed with regard to each of the first conversion image and the second conversion image. Further, the thresholds h1 and h2 may be set such that the region to be associated with the luminance value in the first conversion image and the region to be associated with the luminance value in the second conversion image are not overlapped with each other. The other configurations and operations are the same as those of the first embodiment.

Note that, the configuration of the present embodiment is based on the following knowledge. As for the first conversion image 21, within the region 214 in which the angle β is large, a surface parallel to the optical axis is reflected without being distorted. Hence, the stereo matching can be facilitated. In other words, with regard to the region 214, a probability that the pixel value (disparity) of the second disparity image calculated from the second conversion image 22 is selected is relatively low and a probability that the pixel value (disparity) of the first disparity image calculated from the first conversion image 21 is selected is relatively high. Therefore, with regard to the region 214 in which the angle β is large, using the first conversion image 21 is preferable to using the second conversion image. By not using the second conversion image 22 in the region 214, it is possible to reduce the computational complexity.

In contrast, as for the second conversion image 22, within a region in which the angle β is small, a surface crossing the optical axis is reflected without being distorted, and distortion of a surface parallel to the optical axis is also decreased. Hence, with regard to the region in which the angle β is small, the probability that the pixel value (disparity) of the second disparity image calculated from the second conversion image 22 is selected is higher than the probability that the pixel value (disparity) of the first disparity image calculated from the first conversion image 21 is selected. Therefore, with regard to the region other than the region 214, it is possible to reduce the computational complexity by not using the first conversion image 21.

### Fourth Embodiment

Like the third embodiment, the present embodiment employs the technique of associating the luminance values with a partial region in each of the first conversion image and the second conversion image, in order to reduce the computational complexity. In the third embodiment, the threshold h1 used for the first conversion image and the threshold h2 used for the second conversion image are different from each other. In contrast, in the present embodiment, the same threshold h3 is used for the first conversion image and the second conversion image.

In summary, in the present embodiment, with regard to the first conversion image, the luminance values are associated with a region which satisfies a condition that the angle β is not less than the threshold h3. With regard to the second conversion image, the luminance values are associated with a region which satisfies a condition that the angle β is not greater than the threshold h3.

Hence, in a process of calculating the disparity, there is no overlap region between the first conversion image and the second conversion image, and therefore it is possible to reduce the computational complexity in such an extent. The threshold h3 is not limited to particular one. However, to prevent a decrease in the reliability of the coincidence evaluation by the stereo matching, it is preferable that the threshold h3 is 45 degrees, for example.

As described above, the operations of the first converter 101 and the second converter 102 of the present embodiment are same as those of the second embodiment except the different threshold h3 is used. However, the first conversion image created by the first converter 101 and the second conversion image created by the second converter 102 have no region corresponding to the same angle β. Hence, in the present embodiment, as shown in FIG. 16, an image synthesizing unit 105 configured to synthesize an image from the first conversion image created by the first converter 101 and the second conversion image created by the second converter 102. In other words, in the present embodiment, the arithmetic processing unit 10 further includes the image synthesizing unit 105.

Consequently, the four different images which are the first conversion images and the second conversion images created from the captured images taken by the respective two cameras 1 and 2 are not given to the disparity estimation unit 103. Instead, the two different images synthesized by the image synthesizing unit 105 are given to the disparity estimation unit 103. Hence, the disparity estimation unit 103 creates a single disparity image rather than the two different disparity images which are the first disparity image and the second disparity image. Additionally, the disparity estimation unit 103 creates a single coincidence image rather than the two different coincidence images which are the first coincidence image and the second coincidence image. In other words, the disparity estimation unit 103 performs the associating process one time by use of the two different synthesized images (conversion image) to calculate the disparity.

When an image is synthesized from the first conversion image and the second conversion image, the image may include a discontinuous area at a border between the first conversion image and the second conversion image. When the synthesized image has such a discontinuous area, the reliability of the coincidence evaluation by the stereo matching is likely to be decreased. In other words, when the synthesized image has such a discontinuous area at a border, an object with a different distance is included in the window W1 and the scanning area W2 which include the border, in the stereo matching using the block-matching technique. This causes a decrease in the reliability of the coincidence evaluation.

This adverse effect can be reduced by decreasing the number of pixels of each of the window W1 and the scanning area W2. However, a decrease in the number of pixels of each of the window W1 and the scanning area W2 is likely to cause a decrease in a change in the SAD value. Hence, the accuracy of detecting the corresponding points is decreased.

In contrast, it depends on the threshold h3 whether the border in the synthesized image from the conversion images becomes discontinuous or not. According to FORMULA 4, when β is equal to 45 degrees, Y is equal to Z and therefore α is equal to φ. Hence, when the threshold h3 is 45 degrees, the synthesized image is continuous at the border between the conversion images. In view of this, it is preferable that the threshold h3 is 45 degrees, as mentioned above. Note that, even when the threshold h3 is not 45 degrees, the reliability of the disparity at only a region close to the border is likely to be decreased but the reliability of the disparity at other regions is not likely to be decreased.

As described above, in the stereo camera device of the preset embodiment, with regard to a first region in which the corresponding points are determined by use of either the first conversion image or the second conversion image and a second region in which the corresponding points are determined by use of both the first conversion image and the second conversion image, the first converter 101 and the second converter 102 have functions of determining at least the first region in conformity with a predetermined condition with respect to the first conversion image and the second conversion image.

In other words, in the stereo camera device of the present embodiment, the first converter 101 is configured to decide a first extraction region (region 214) used for extracting the corresponding point from the first conversion image in accordance with the predetermined first decision condition, and calculate a pixel value regarding a pixel included in the first extraction region (region 214), and not calculate a pixel value regarding a pixel not included in the first extraction region (region 214). The second converter 102 is configured to decide a second extraction region (region 224) used for extracting the corresponding point from the second conversion image in accordance with the predetermined second decision condition, and calculate a pixel value regarding a pixel included in the second extraction region (region 224), and not calculate a pixel value regarding a pixel not included in the second extraction region (region 224).

Particularly, in the stereo camera device of the present embodiment, the first decision condition and the second decision condition are the same.

The other configurations and operations are the same as those of the first embodiment and the second embodiment. Since the first conversion image and the second conversion image do not overlap with each other, the computation complexity by the disparity estimation unit 103 is more decreased in the present embodiment than in the second embodiment. Consequently, it is possible to obtain the three-dimensional information of the real space with the computational complexity less than that of the second embodiment. Further, at the border, the first conversion image and the second conversion image have the same pixel value. Hence, even when the stereo matching using the block-matching technique is conducted with regard to the region including the border, the reliability of the degree of coincidence can be improved. In other words, since the reliability of the degree of coincidence is improved, the reliability of the stereo matching is also improved.

### Fifth Embodiment

As described in the first embodiment, there are characteristics which show that distortion in the direction parallel to the optical axis is reduced at the opposite ends in the longitudinal direction of the first conversion image and distortion in the plane perpendicular to the optical axis is reduced at the center of the second conversion image. For this reason, by appropriately selecting regions from the first conversion images and the second conversion images in a similar manner as the third and fourth embodiments, it is possible to obtain the corresponding points by use of regions in which distortion is reduced at the opposite ends in the longitudinal direction and the center. However, in each of the first conversion image and the second conversion image, distortion at the opposite ends in the lateral direction is relatively large. Hence, the reliability of the disparity in such a region is lower than that in the other region, even when either the first conversion image or the second conversion image is used.

In view of this problem, in the present embodiment, to improve the reliability of the disparity calculated, the number of cameras is increased. For example, cameras are installed on the center of the ceiling in the room. In this case, according to the first conversion image, distortion is reduced at the opposite ends in the longitudinal direction (β direction) with regard to images of objects (e.g., wall surfaces and pillars) extending along the vertical direction. Further, according to the second conversion image, distortion is reduced at the center with regard to images of objects (e.g., floor surfaces and upper surfaces of desks) extending along the horizontal direction. Hence, for example, two pairs of cameras for determining the three-dimensional information with the stereo vision are installed and are arranged such that the longitudinal axes (β directions) of the first conversion images of the two pairs are perpendicular to each other. Consequently, it is possible to obtain an image in which distortion is reduced with regard to all of wall surfaces and pillars in the room.

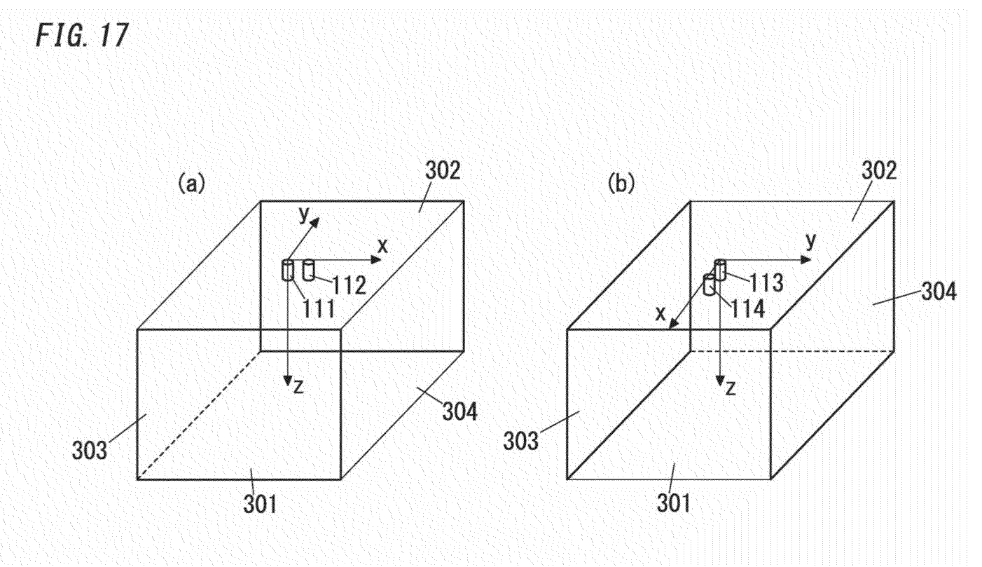

The aforementioned knowledge teaches that by providing two pairs of two cameras and using total four cameras, an image in which distortion is reduced can be obtained for all the regions in the room. For example, as shown in FIG. 17 (a), when two cameras 111 and 112 for the stereo vision are arranged in the left and right direction of the figure on the center of the ceiling, distortion is reduced with regard to regions corresponding to wall surfaces 301 and 302 extending along the left and right direction in the first conversion image. In contrast, as shown in FIG. 17 (b), when cameras 113 and 114 for the stereo vision are placed at positions that are rotated around an axis normal to the ceiling surface by 90 degrees from the positions illustrated in FIG. 17 (a), distortion is reduced with regard to regions corresponding to wall surfaces 303 and 304 perpendicular to the wall surfaces 301 and 302 in the first conversion image.

In the present embodiment, one of the four cameras 111, 112, 113, and 114 is shared by both the pairs. The following explanation is made to instance that achieves, by using only three cameras in the aforementioned manner, the same function as the case where four cameras are used. With reference to the instance shown in FIG. 17, in the following explanation, one camera is used as the cameras 111 and 113. In summary, the three cameras 111, 112, and 114 are used. The three cameras 111, 112, 114 are arranged such that the optical centers thereof are in positions of vertexes of an isosceles right triangle, respectively. In brief, the shared camera 111 is placed equidistant from the remaining cameras 112 and 114. Note that, it is not always necessary that the optical centers are in positions of vertexes of an isosceles right triangle, respectively. For example, it is allowed that the three cameras 111, 112, 114 are arranged such that the optical centers thereof are in positions of vertexes of an equilateral triangle.

The following explanation is made to an example where the cameras 111, 112, and 114 are placed at positions of vertexes of an isosceles right triangle respectively. To measure the three-dimensional information with the stereo vision, two different pairs of two cameras respectively selected from the three cameras 111, 112, and 114 are used together. In brief, the measurement of the three-dimensional information with the stereo vision is performed by use of a pair of the two cameras 111 and 112 and a pair of the two cameras 111 and 114. The measurement of the three-dimensional information of each pair is performed in a similar manner as the first embodiment.

When four cameras are used, two cameras of each pair can be arranged in the horizontal direction (x-direction) of their captured images. However, in a case where three cameras are used, when one pair of two cameras (e.g., the cameras 111 and 112) are arranged in the horizontal direction (x-direction) of their captured images, it is impossible to arrange the other pair of two cameras (e.g., the cameras 111 and 114) in the horizontal direction of their captured images. In this case, the camera 114 is placed to have its horizontal direction parallel or perpendicular to the direction of the base line of the cameras 111 and 112.

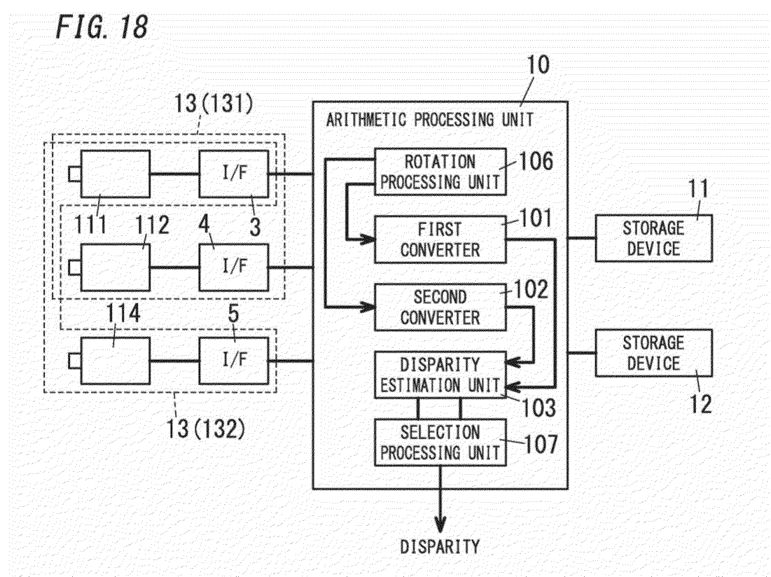

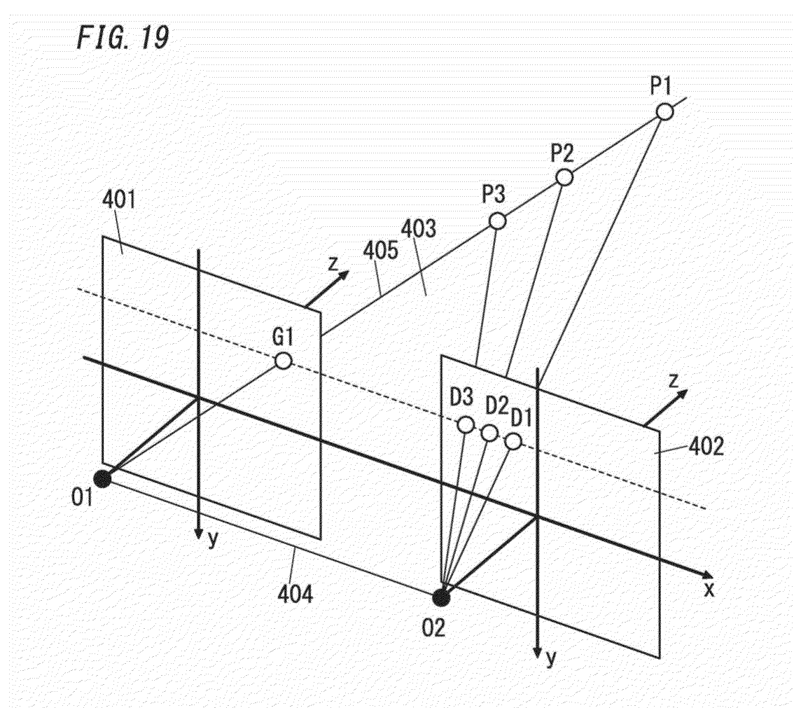

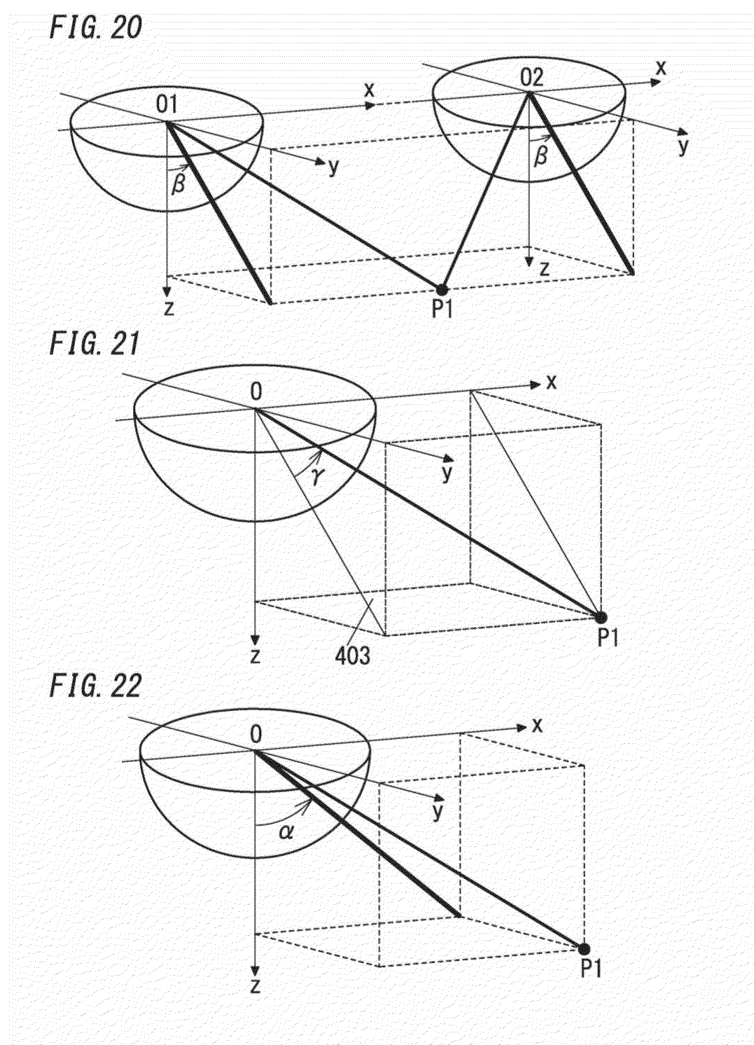

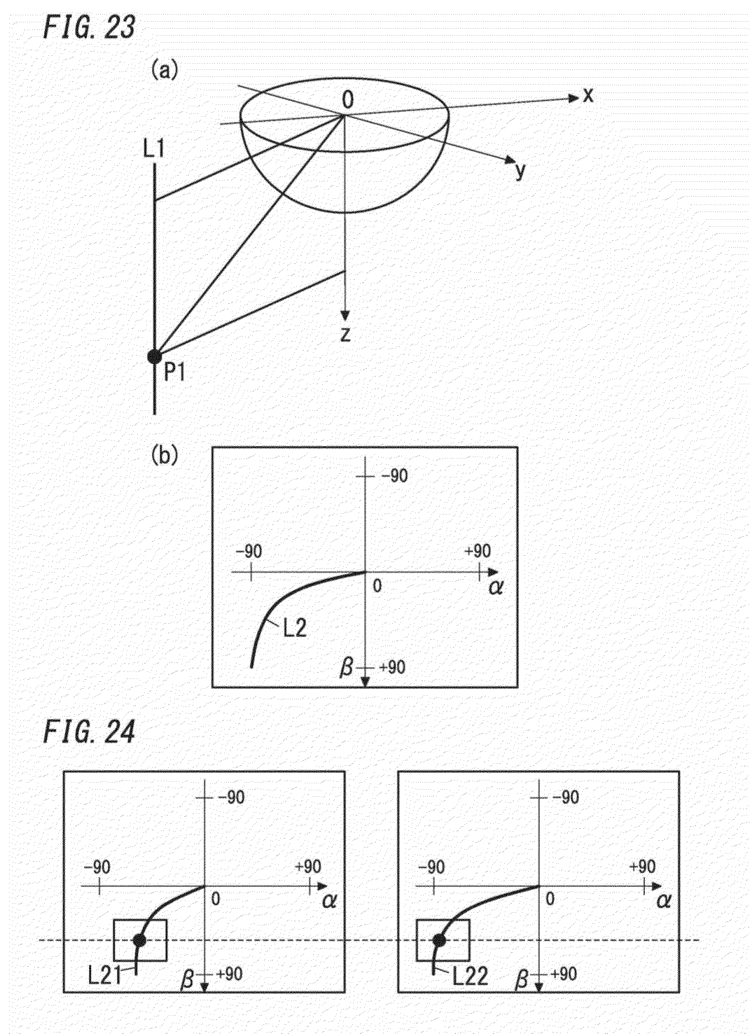

Hence, to create the first conversion image and the second conversion image with the same formulae as the first embodiment, a rotation processing unit 106 for rotating the captured images by 90 degrees is necessary as shown in FIG. 18. The rotation processing unit 106 is provided such that the process performed by the rotation processing unit 106 is prior to the processes performed by the first converter 101 and the second converter 102. When the direction of the base line is not identical to the horizontal direction of the image before conversion, it is possible to have the direction of the base line identical to the horizontal direction of the image before conversion, by appropriately rotating the captured image with the rotation processing unit 106. In this regard, the three captured images respectively taken by the three cameras 111, 112, and 114 are stored in the storage device 12. The rotation processing unit 106 needs only a function of changing a direction of reading-out pixels, as necessary.

As described above, by providing the rotation processing unit 106, it is possible to create the first conversion image and the second conversion image with the same formulae (conversion equations) as the first embodiment. Note that, as an alternative to rotation of the captured image by the rotation processing unit 106, conversion that is equivalent to the above rotation may be performed with mathematical formulae for converting the captured image into the first conversion image and the second conversion image respectively.

According to the configuration described above, the two pairs of first conversion images and the two pairs of second conversion images are created. The processing for each set is the same as the first embodiment, and the disparities are calculated by use of the pair of first conversion images and the pair of second conversion images. Since the disparity is calculated for each pair, one of the disparities having the reliability higher than that for the other is selected by a selection processing unit 107. The reliability of the disparity can be evaluated with evaluation of the degree of coincidence Ds in a similar manner as the first embodiment. Note that, in this process, the selection processing unit 107 evaluates the degree of coincidence Ds. Hence, the first coincidence image and the second coincidence image are also given to the selection processing unit 107.

As shown in FIG. 18, the stereo camera device of the present embodiment includes a plurality of (two, in FIG. 18) stereo camera units 13 (131 and 132). The plurality of stereo camera units 131 and 132 are arranged such that the first axes thereof cross each other and the second axes thereof are parallel to each other. The disparity estimation unit 103 is configured to calculate the disparity regarding the desired point for each of the plurality of stereo camera units 131 and 132. The arithmetic processing unit 10 includes the selection processing unit 107. The selection processing unit 107 is configured to calculate a degree of reliability (degree of coincidence Ds, in the present embodiment) for each disparity calculated by the disparity estimation unit 103, and select the disparity having the highest degree of reliability from the disparities estimated by the disparity estimation unit 103.

Additionally, in the stereo camera device of the present embodiment, one (the camera 111 in the present embodiment) of the two cameras of one (the stereo camera unit 131) of the plurality of stereo camera units 13 is used as one camera of another stereo camera unit (stereo camera unit 132).

In other words, the stereo camera device of the present embodiment can be considered as a stereo camera system. This stereo camera system includes the two stereo camera devices. Each stereo camera device includes a pair of two cameras, and the two pairs of cameras are arranged such that the first directions of the two pairs cross each other and that the optical axes of cameras are parallel to each other. The stereo camera system includes the selection processing unit 107 configured to select a disparity having higher reliability from the disparities estimated by the disparity estimation units 103 provided to the respective stereo camera devices.

Especially, in the instance shown in FIG. 18, the arithmetic processing unit 10 of one of the two stereo camera devices is used as the arithmetic processing unit 10 of the other stereo camera device. In summary, the plurality of stereo camera devices share the arithmetic processing unit 10.

Further, in the instance shown in FIG. 18, the selection processing unit 107 is included in the arithmetic processing unit 10. However, it is not always necessary that the selection processing unit 107 is included in the arithmetic processing unit 10.

Furthermore, in the stereo camera system of the present embodiment, one of two cameras provided for each stereo camera device is used as a shared camera.

The other configurations and operations are same as those of the first embodiment and explanation thereof are deemed unnecessary. Further, the present embodiment can be used in combination with the configurations and operations of the second to fourth embodiments. As described above, in the second conversion image, distortion is reduced at the center with regard to objects such as floor surfaces and upper surfaces of desks extending along the horizontal direction. In the first conversion image, distortion is reduced at the opposite ends in the longitudinal direction with regard to objects such as wall surfaces and pillars extending along the vertical direction. Hence, when the region is selected in a similar manner as the third or fourth embodiment, by selecting regions at the longitudinal opposite ends of the first conversion image for each pair, the search for the corresponding points in the entire room can be facilitated. Further, when the region is evaluated about whether the search for the corresponding points is facilitated, it is sufficient that the first conversion image and the second conversion image are evaluated for each pair, and further similar evaluation is performed on the different pairs. In a case where the evaluation is performed on the different pairs, the differences between the edge intensities are compared, and the pair having the larger difference between the edge intensities is used preferentially.

1. A stereo camera device comprising:
a stereo camera unit; and
an arithmetic processing unit,
wherein:
the stereo camera unit includes a pair of cameras for capturing images of a predetermined space, and is configured to provide the captured images respectively by the pair of cameras to the arithmetic processing unit;
the arithmetic processing unit includes a first converter, a second converter, and a disparity estimation unit;
the first converter is configured to convert the captured images by the pair of cameras into first conversion images;
the first conversion image is defined as an image in which a position of a pixel is represented by two-dimensional orthogonal coordinates defined by a first angle around a first axis and a second angle around a second axis;
the second converter is configured to convert the captured images by the pair of cameras into second conversion images;
the second conversion image is defined as an image in which a position of a pixel is represented by two-dimensional orthogonal coordinates defined by the first angle and a third angle around a third axis;
the first axis is defined by a straight line connecting optical centers of the pair of cameras to each other;
the second axis is defined by an optical axis of the camera;
the third axis is defined by an axis orthogonal to the first axis and the second axis; and
the disparity estimation unit is configured to calculate a disparity regarding a desired point in the space based on the first conversion images obtained by the first converter and the second conversion images obtained by the second converter.

2. The stereo camera device as set forth in claim 1, wherein:
the disparity estimation unit is configured to calculate corresponding points regarding the desired point from the two first conversion images respectively corresponding to the pair of cameras, and calculate a first disparity regarding the desired point based on the corresponding points, and evaluate a first degree of coincidence between the corresponding points of the two first conversion images;
the disparity estimation unit is configured to calculate corresponding points regarding the desired point from the two second conversion images respectively corresponding to the pair of cameras, and calculate a second disparity regarding the desired point based on the corresponding points, and evaluate a second degree of coincidence between the corresponding points of the two second conversion images; and
the disparity estimation unit is configured to compare the first degree of coincidence with the second degree of coincidence with regard to the same desired point, and select the first disparity as the disparity regarding the desired point when the first degree of coincidence is higher than the second degree of coincidence, and select the second disparity as the disparity regarding the desired point when the first degree of coincidence is lower than the second degree of coincidence.

3. The stereo camera device as set forth in claim 2, wherein:
the arithmetic processing unit further includes a region evaluation unit;
the region evaluation unit is configured to calculate a first evaluation value regarding a change in a luminance value with regard to a first pixel of the first conversion image and a second evaluation value regarding a change in a luminance value with regard to a second pixel of the second conversion image corresponding to the first pixel;
the region evaluation unit is configured to calculate a difference between the first evaluation value and the second evaluation value and compare the difference with a predetermined threshold;
the region evaluation unit is configured to
compare the change in the luminance value of the first pixel and the change in the luminance value of the second pixel when the difference exceeds the threshold, and
select a first condition for the first pixel and the second pixel when the change in the luminance value of the first pixel exceeds the change in the luminance value of the second pixel, and
select a second condition for the first pixel and the second pixel when the change in the luminance value of the first pixel falls below the change in the luminance value of the second pixel, and
select a third condition for the first pixel and the second pixel when the difference is equal to the threshold or less; and
the region evaluation unit is configured to
when the first condition is selected for the first pixel and the second pixel, calculate the corresponding points by use of the first conversion images with regard to the first pixel and the second pixel, and
when the second condition is selected for the first pixel and the second pixel, calculate the corresponding points by use of the second conversion images with regard to the first pixel and the second pixel, and
when the third condition is selected for the first pixel and the second pixel, calculate the corresponding points by use of the first conversion images and the second conversion images with regard to the first pixel and the second pixel.

4. The stereo camera device as set forth in claim 2, wherein:
the first converter is configured to decide a first extraction region used for extracting the corresponding point from the first conversion image in accordance with a predetermined first decision condition, and calculate a pixel value regarding a pixel included in the first extraction region, and not calculate a pixel value regarding a pixel not included in the first extraction region; and
the second converter is configured to decide a second extraction region used for extracting the corresponding point from the second conversion image in accordance with a predetermined second decision condition, and calculate a pixel value regarding a pixel included in the second extraction region, and not calculate a pixel value regarding a pixel not included in the second extraction region.

5. The stereo camera device as set forth in claim 1, wherein:
the stereo camera device comprises a plurality of stereo camera units;
the plurality of stereo camera units are arranged such that the first axes thereof cross each other and the second axes thereof are parallel to each other;
the disparity estimation unit is configured to calculate the disparity regarding the desired point for each of the plurality of stereo camera units;
the arithmetic processing unit includes a selection processing unit; and
the selection processing unit is configured to calculate a degree of reliability for each disparity calculated by the disparity estimation unit, and select the disparity having the highest degree of reliability from the disparities estimated by the disparity estimation unit.

6. The stereo camera device as set forth in claim 5, wherein
one of the two cameras of one of the plurality of stereo camera units is used as one camera of another stereo camera unit.

7. A computer-readable recording medium storing a program used in a computer connected to a stereo camera unit, wherein:
the stereo camera unit includes a pair of cameras for capturing images of a predetermined space, and is configured to provide the captured images respectively by the pair of cameras to the arithmetic processing unit;
the pair of cameras are arranged such that optical axes thereof are parallel to each other and fields of view thereof are overlapped with each other;
the program is designed to have the computer functions a first converter, a second converter, and a disparity estimation unit;
the first converter is configured to convert the captured images by the pair of cameras into first conversion images;
the first conversion image is defined as an image in which a position of a pixel is represented by two-dimensional orthogonal coordinates defined by a first angle around a first axis and a second angle around a second axis;
the second converter is configured to convert the captured images by the pair of cameras into second conversion images;
the second conversion image is defined as an image in which a position of a pixel is represented by two-dimensional orthogonal coordinates defined by the first angle and a third angle around a third axis;
the first axis is defined by a straight line connecting optical centers of the pair of cameras to each other;
the second axis is defined by an optical axis of the camera;
the third axis is defined by an axis orthogonal to the first axis and the second axis; and
the disparity estimation unit is configured to calculate a disparity regarding a desired point in the space based on the first conversion images obtained by the first converter and the second conversion images obtained by the second converter.
